(19) United States
(12) Patent Application Publication
(10) Pub. No.: US 2024/0317126 A1
(43) Pub. Date: Sep. 26, 2024

(54) PANEL FRAME STRUCTURE

(71) Applicant: TS TECH CO., LTD., Asaka-shi, Saitama (JP)

(72) Inventors: Takeshi SATO, Shioya-gun, Tochigi (JP); Hidetaka YONEHARA, Shioya-gun, Tochigi (JP); Takahiro NIIMURA, Shioya-gun, Tochigi (JP); Junya ISHIHARA, Shioya-gun, Tochigi (JP)

(21) Appl. No.: 18/579,018

(22) PCT Filed: Jul. 19, 2022
(86) PCT No.: PCT/JP2022/028029

§ 371 Date: Jan. 12, 2024

Related U.S. Application Data
(60) Provisional application No. 63/203,291, filed on Jul. 16, 2021.
(60) Provisional application No. 63/224,035, filed on Jul. 21, 2021.
(60) Provisional application No. 63/263,956, filed on Nov. 12, 2021.

(30) Foreign Application Priority Data
Mar. 31, 2022 (JP) 2022-058082

(51) Int. Cl. B60N 2/68; B60N 2/75

(52) U.S. Cl. CPC B60N 2/68; B60N 2/75

(57) ABSTRACT

A panel frame structure includes a panel frame, an upper frame bonded along an upper end of the panel frame, a side frame bonded along a lateral end of the panel frame, and a mounting bracket for a lock device. The mounting bracket has a portion overlapped on the upper frame when viewed from a front-back direction.

### CROSS REFERENCE TO RELATED APPLICATIONS

This application is the U.S. National Stage entry of International Application No. PCT/JP2022/028029, filed on Jul. 19, 2022, which claims priority to U.S. Provisional Patent Application No. 63/203,291, filed on Jul. 16, 2021; U.S. Provisional Patent Application No. 63/224,035, filed on Jul. 21, 2021; U.S. Provisional Patent Application No. 63/263,956, filed on Nov. 12, 2021; and Japanese Patent Application No. 2022-058082, filed on Mar. 31, 2022, all of which are incorporated herein by reference in their entireties for all purposes.

### TECHNICAL FIELD

The present invention relates to a panel frame structure.

### BACKGROUND ART

JP 2015-163506A discloses an example in which a mounting bracket that holds a lock device for fixing a seat back of a conveyance seat to a standing state is deployed on a side frame of a seat frame.

### CITATION LIST

### Patent Literature

Patent Document 1: JP 2015-163506A

### SUMMARY OF INVENTION

### Technical Problem

However, the above-described conventional panel frame structure has room for improvement in strength of the structure.

An object of the present invention, which has been conceived in light of the circumstances described above, is to improve the strength of a panel frame structure.

### Solution to Problem

In order to solve the above problems, in a first aspect, a panel frame structure includes:
a panel frame;
an upper frame bonded along an upper end of the panel frame;
a side frame bonded along a lateral end of the panel frame; and
a mounting bracket for a lock device,
wherein the mounting bracket has a portion overlapped on the upper frame when viewed in a front-back direction.

A second aspect is the panel frame structure according to the first aspect,
wherein the mounting bracket is in a state covering at least part of the upper frame.

A third aspect is the panel frame structure according to the first aspect,
wherein the side frame, the mounting bracket, and the upper frame have overlapped portions when viewed in the front-back direction.

A fourth aspect is the panel frame structure according to the first aspect,
wherein a clearance space in which a fastener for mounting the lock device is arranged is provided between the mounting bracket and the upper frame.

A fifth aspect is the panel frame structure according to the fourth aspect,
wherein the fastener is bonded to a sidewall that forms the clearance space.

A sixth aspect is the panel frame structure according to the fourth aspect,
wherein the mounting bracket has the clearance space on an inner side of a region protruding in the front-back direction.

A seventh aspect is the panel frame structure according to the first aspect,
wherein the mounting bracket is bonded to at least one of the upper frame or the side frame and to the panel frame.

An eighth aspect is the panel frame structure according to the first aspect,
wherein a clearance space in which the lock device is stored is provided between the mounting bracket and the upper frame.

A ninth aspect is the panel frame structure according to the first aspect, further comprising:
an armrest bracket that supports an armrest; and
a corner bracket bonded to a corner of the panel frame,
wherein the armrest bracket has a portion overlapped on the side frame or the corner bracket when viewed in the front-back direction.

A tenth aspect is the panel frame structure according to the ninth aspect,
wherein the armrest bracket is bonded to the side frame or the corner bracket.

An eleventh aspect is the panel frame structure according to the ninth aspect,
wherein the armrest bracket is bonded to neither the side frame nor the corner bracket.

A twelfth aspect is the panel frame structure according to the ninth aspect,
wherein the armrest bracket is shaped to skirt the side frame or the corner bracket in the front-back direction.

A thirteenth aspect is the panel frame structure according to the first aspect,
wherein the upper frame is shaped to have an open cross-section, and
wherein a protruding/recessed reinforcement is provided at a position to be an inner side of an opening of the open cross-section of the upper frame on the panel frame.

A fourteenth aspect is the panel frame structure according to the first aspect,
wherein the upper frame or the side frame is shaped to have an open cross-section, and
wherein a protruding/recessed reinforcement is provided to be aligned with an outside of an opening of the open cross-section of the upper frame or the side frame on the panel frame side.

A fifteenth aspect is the panel frame structure according to the first aspect,
wherein a netted bead is formed on the panel frame.

With the first aspect, the mounting bracket has a portion overlapped on the upper frame when viewed in the front-back direction. High rigidity is thus obtained at the overlapped portions of the mounting bracket and the upper frame, which accomplishes improvement in strength of the panel frame structure.

With the second aspect, the mounting bracket is in the state covering at least part of the upper frame. High rigidity is thus obtained at the portion where the mounting bracket covers the upper frame, which accomplishes improvement in strength of the panel frame structure.

With the third aspect, the side frame, the mounting bracket, and the upper frame have overlapped portions when viewed in the front-back direction. Higher rigidity is thus obtained at their overlapped portions, which accomplishes further improvement in strength of the panel frame structure.

With the fourth aspect, the clearance space in which the fastener for mounting the lock device is arranged is provided between the mounting bracket for the lock device and the upper frame. The fastener is thus arranged without protruding from the surface of the panel frame structure. The utilization of the clearance space also accomplishes size reduction and compactification of the periphery of the mounting bracket.

With the fifth aspect, the fastener is bonded to the sidewall that forms the clearance space. This eliminates the need to press the fastener when the lock device is mounted, which accomplishes facilitation of an assembling work.

With the sixth aspect, the mounting bracket has the clearance space on the inner side of the region protruding in the front-back direction. A surface on which the lock device is to be mounted is thus ensured widely in the front-back direction. The lock device is thus mounted stably and with high strength.

With the seventh aspect, the mounting bracket is bonded to at least one of the upper frame or the side frame and to the panel frame. A load is thus distributed to the panel frame and the upper frame or the side frame if an external force is applied to the lock device, and the mounting strength of the lock device is maintained high. Deflection of the panel frame structure under the external force applied to the lock device is also prevented.

With the eighth aspect, the clearance space in which the lock device is stored is provided between the mounting bracket and the upper frame. The lock device is thus protected. Furthermore, the lock device is arranged without protruding from the surface of the panel frame structure. The utilization of the clearance space also accomplishes size reduction and compactification of the periphery of the lock device.

With the ninth aspect, the armrest bracket has the portion overlapped on the side frame or the corner bracket when viewed in the front-back direction. This eliminates the need to arrange the armrest bracket to skirt the side frame or the corner bracket, which accomplishes size reduction of the panel frame structure.

High rigidity is obtained at the overlapped portions of the armrest bracket and the side frame or the corner bracket, which accomplishes improvement in strength of the panel frame structure.

With the tenth aspect, the armrest bracket is bonded to the side frame or the corner bracket, which accomplishes improvement in mounting strength.

With the eleventh aspect, the armrest bracket is not bonded to the side frame or the corner bracket. Thus, room for allowing deflection of the overlapped portion of the armrest bracket on the side frame or the corner bracket is left, and a load applied to the armrest is absorbed to prevent occurrence of breakage, deformation, damage, or the like.

With the twelfth aspect, the armrest bracket is shaped to skirt the side frame or the corner bracket in the front-back direction. Bending of the skirting shape thus increases the rigidity of the armrest bracket. The armrest bracket skirts the side frame or the corner bracket while being bonded to the panel frame, and the armrest bracket is mounted with high strength.

With the thirteenth aspect, the protruding/recessed reinforcement is provided at the position to be the inner side of the opening of the open cross-section of the upper frame on the panel frame. The upper frame is thus bonded to the portion of the panel frame increased in rigidity by the reinforcement, which increases the bonding strength of the upper frame or the side frame.

With fourteenth aspect, the protruding/recessed reinforcement is provided to be aligned with the outside of the opening of the open cross-section of the upper frame or the side frame on the panel frame. The upper frame or the side frame is thus bonded to the vicinity of the portion of the panel frame increased in rigidity by the reinforcement, which increases the bonding strength of the upper frame or the side frame.

With the fifteenth aspect, the netted bead is formed on the panel frame. The rigidity against a load in the direction vertical to the plane of the panel frame is thus increased, which accomplishes improvement in strength of the entire panel frame structure.

### BRIEF DESCRIPTION OF DRAWINGS

FIG. 1 This is a front view illustrating a front surface side of a panel frame structure in an embodiment [1] related to the panel frame structure.

FIG. 2 This is a perspective view of a right end of an upper frame in a state in which a mounting bracket has been removed.

FIG. 3 This is a cross-sectional view taken along the line C-C in FIG. 1.

FIG. 4 This is a cross-sectional view taken along the line B-B in FIG. 1.

FIG. 5 This is a cross-sectional view taken along the line E-E in FIG. 1.

FIG. 6 This is a cross-sectional view taken along the line F-F in FIG. 1.

FIG. 7 This is a perspective view of a right upper portion of the panel frame structure.

FIG. 8 This is a cross-sectional view taken along the line A-A in FIG. 1.

FIG. 9 This is a cross-sectional view taken along the line D-D in FIG. 1.

FIG. 10 This is a magnified perspective view of a left lower portion of the panel frame structure.

FIG. 11 This is a perspective view of the upper frame having a guide.

FIG. 12 This is a front view illustrating a front surface side of a panel frame structure including a mounting bracket in another form.

FIG. 13 This is a cross-sectional view taken along the line G-G in FIG. 12.

FIG. 14 This is a front view of a panel frame structure in a case in which a mounting bracket is diverted to an airbag module.

FIG. 15 This is a cross-sectional view taken along the line H-H in FIG. 14.

FIG. 16 This is a cross-sectional view taken along the line H-H in FIG. 14 in an example in which the flange has been refined.

FIG. 17 This is a perspective view of a cushion frame structure in an embodiment related to the cushion frame structure of a conveyance seat.

FIG. 18 This is a plan view of the cushion frame structure.

FIG. 19 This is a front view of the cushion frame structure.

FIG. 20 This is a rear view of the cushion frame structure.

FIG. 21 This is a left side view of the cushion frame structure.

FIG. 22 This is a cross-sectional view taken along the line A-A in FIG. 18.

FIG. 23 This is a cross-sectional view taken along the line B-B in FIG. 19.

FIG. 24 This is a front view illustrating a front surface side of a panel frame structure in an embodiment [2] related to the panel frame structure.

FIG. 25 This is a cross-sectional view of the panel frame structure taken along the line A-A in FIG. 24.

FIG. 26 This is a partial magnified view of a front surface of the panel frame structure.

FIG. 27 This is a partial perspective view of the panel frame structure.

FIG. 28 This is a cross-sectional view of the panel frame structure taken along the line B-B in FIG. 26.

FIG. 29 This is a partial magnified view of a right upper portion of the panel frame structure.

FIG. 30 This is a perspective view of the panel frame structure to which another example of a frame-like portion of a front panel frame is applied.

FIG. 31 This is a schematic diagram of a front view of a panel frame structure to which an example of another form of a coupled portion is applied.

FIG. 32 This is a schematic diagram of a front view of a panel frame structure to which an example of still another form of a coupled portion is applied.

FIG. 33 This is a schematic diagram of a front view of a panel frame structure to which an example of still another form of a coupled portion is applied.

FIG. 34 This is a schematic diagram of a front view of a panel frame structure to which an example of still another form of a coupled portion is applied.

FIG. 35 This is a schematic diagram of a front view of a panel frame structure to which an example of still another form of a coupled portion is applied.

FIG. 36 This is a schematic diagram of a front view of a panel frame structure to which an example of still another form of a coupled portion is applied.

FIG. 37 This is a schematic diagram of a front view of a panel frame structure to which an example of still another form of a coupled portion is applied.

FIG. 38 This is a schematic diagram of a front view of a panel frame structure to which an example of still another form of a coupled portion is applied.

FIG. 39 This is a schematic diagram of a front view of a panel frame structure to which an example of still another form of a coupled portion is applied.

FIG. 40 This is a schematic diagram of a front view of a panel frame structure to which an example of still another form of a coupled portion is applied.

FIG. 41 This is a schematic diagram of a front view of a panel frame structure to which an example of another form of reinforcements is applied.

FIG. 42 This is a schematic diagram of a rear view of a panel frame structure to which an example of another form of reinforcements is applied.

FIG. 43 This is a perspective view illustrating a front surface side of a panel frame structure in an embodiment [3] related to the panel frame structure.

FIG. 44 This is a perspective view illustrating a back surface side of the panel frame structure in FIG. 43.

FIG. 45 This is a partial magnified perspective view of the panel frame structure in FIG. 43.

### DESCRIPTION OF EMBODIMENTS

### <1> Embodiment [1] Related to Panel Frame Structure

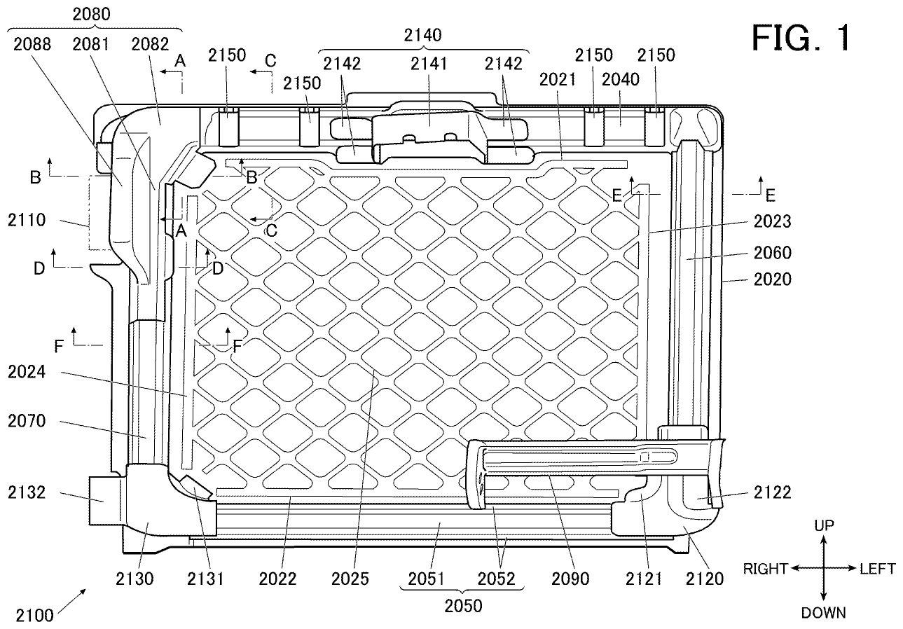

An embodiment [1] related to a panel frame structure will be described based on FIG. 1 to FIG. 16.

Technically preferable various limitations will be imposed on the following embodiments in order to carry out the present invention, but are not intended to limit the scope of the present invention to the following embodiment and illustrated examples.

The present embodiment is a panel frame structure to be applied to a backrest of a conveyance bench seat.

Although a conveyance provided with a bench seat to which the panel frame structure which will be described below is applied includes every conveyance that accommodates a human being and moves, such as a vessel, a flight vehicle, and a vehicle, the present embodiment will exemplify a case in which the panel frame structure is applied to a bench seat of a vehicle, in particular, an automobile.

FIG. 1 is a front view illustrating a front surface side of a panel frame structure 2100.

In each of the drawings described in the present embodiment, up, down, left, right, front, and back directions respectively indicate directions in a state in which the panel frame structure 2100 is mounted on a vehicle. Hereinafter, each part of the panel frame structure 2100 will be described based on the directions in the above-described mounted state. In FIG. 1, this side of the sheet of drawing indicates the “front”, the far side indicates the “back”, the left side in a state in which the panel frame structure 2100 is oriented to the front is the “left”, and the right side is the “right.”

More precisely, each panel frame structure 2100 is mounted on a vehicle in a state in which its upper end is somewhat inclined backward, but unless otherwise specified, a plate surface of each panel frame structure 2100 shall be in a state lying in the up-down direction and the left-right direction for the sake of description.

The panel frame structure 2100 is intended for a vehicle and utilized as a framework of a backrest of a bench seat. The panel frame structure 2100 is utilized for a backrest of a two-person bench seat. It is assumed that a panel frame structure for another one-person seat or a multiple-person seat is arranged on the left of and adjacent to this panel frame structure 2100.

A foam-molded pad is mounted on the panel frame structure 2100 so as to enclose the panel frame structure 2100 from the front side. A surface skin is then pulled over a surface of the pad. Pulling over indicates that the surface skin covering the surface of the pad lies over the surface of the pad under tension.

### [Overview of Panel Frame Structure]

The panel frame structure 2100 includes a panel frame 2020, an upper frame 2040, a lower frame 2050, a pair of left and right side frames 2060, 2070, a lock device 2110, a mounting bracket 2080, an armrest bracket 2090, left and right corner brackets 2120, 2130, a belt guide 2140, a plurality of headrest supports 2150, and the like.

The panel frame 2020 is a metal plate of steel, aluminum alloy, or the like, and is deployed on the vehicle seat in a state in which upper and lower sides of the panel frame 2020 extend in the left-right direction and left and right sides extend in the up-down direction as illustrated in FIG. 1.

### [Overview of Panel Frame]

The above-described panel frame 2020 is a metal plate having a substantially rectangular shape whose plate surface shape in front view is slightly longer in the left-right direction, as illustrated in FIG. 1.

One side in a direction vertical to the plate surface of the panel frame 2020 shall indicate the front, and the other shall indicate the back. Most of respective components which will be described below are provided at the front surface side of the panel frame 2020.

The respective components of the panel frame structure 2100 shall be bonded through welding, more preferably through laser welding in a case of being simply referred to as being “bonded.” However, a welding method other than laser welding may be used, or a bonding method other than welding may be used.

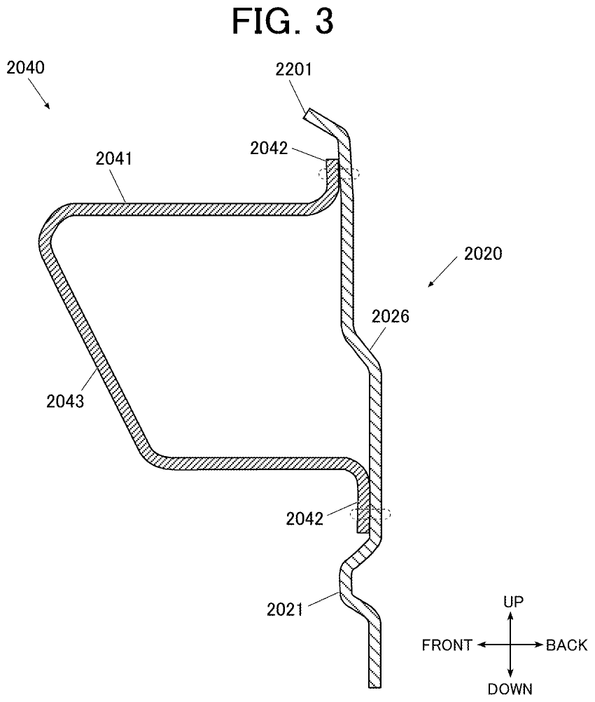

The panel frame 2020 has a low-height, circumferential wall-like flange 2201 formed to rise forward over substantially the entire circumference of an outer edge portion of the panel frame 2020 (see FIG. 3 to FIG. 6). Only the vicinity of a right end upper portion as well as lower portions of a left end and a right end of the panel frame 2020 to be mounted positions of the mounting bracket 2080 and the left and right corner brackets 2120, 2130 which will be described later have been removed from this flange 2201.

The upper frame 2040, the lower frame 2050, the left side frame 2060, and the right side frame 2070 are bonded separately to an upper end, a lower end, a left end, and a right end of the front surface of the panel frame 2020.

These four frames 2040 to 2070 are provided on the inner side relative to the outer edge portion of the panel frame 2020 and along the outer edge portion. The four frames 2040 to 2070 are coupled integrally to constitute a rectangular frame shape.

Parallel reinforcements (protruding/recessed reinforcements) 2021 to 2024 implemented by linear beads are formed in inner regions of the four frames 2040 to 2070 of the panel frame 2020. The respective parallel reinforcements 2021 to 2024 are provided adjacent to the respective frames 2040 to 2070 in parallel to the respective frames 2040 to 2070.

Each of the parallel reinforcements 2021 to 2024 is a ridge protruding forward on the front surface of flat surface of the panel frame 2020 and recessed forward in the back surface.

Only the parallel reinforcement 2021 is not completely linear, but has a central portion shaped to skirt a bonded portion of the belt guide 2140 and bypass downward.

The expression “ . . . reinforcements” in the following description shall indicate portions or members having rigidity higher than the rigidity of a flat plate because of three-dimensional structures such as ridges, frame shapes, protrusions, and folds.

A central reinforcement 2025 implemented by a netted bead is formed in the entire region on the inner side of the four parallel reinforcements 2021 to 2024 on the panel frame 2020. The central reinforcement 2025 includes net-like (lattice-shaped) composite ridges protruding forward on the front surface of the panel frame 2020 and recessed forward in the back surface. Quadrangles aligned regularly in an oblique direction constitute the net pattern of the central reinforcement 2025. The quadrangles may be any of squares, rectangles, rhombi, or parallelograms.

### [Upper Frame]

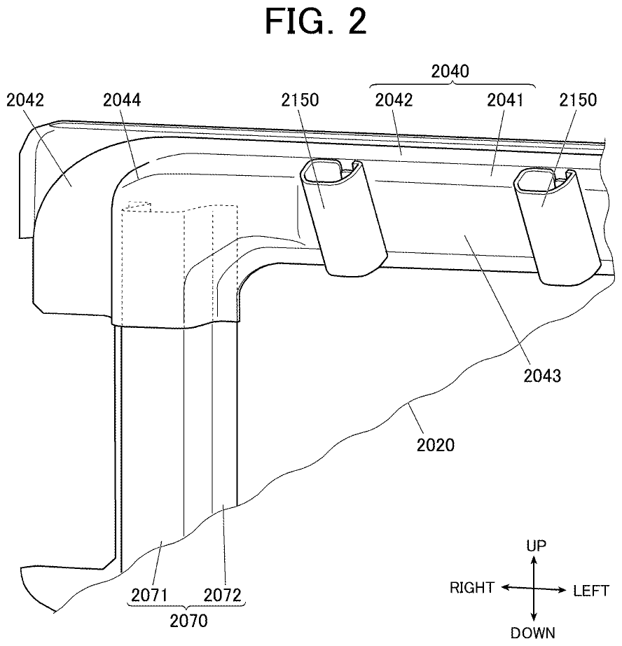

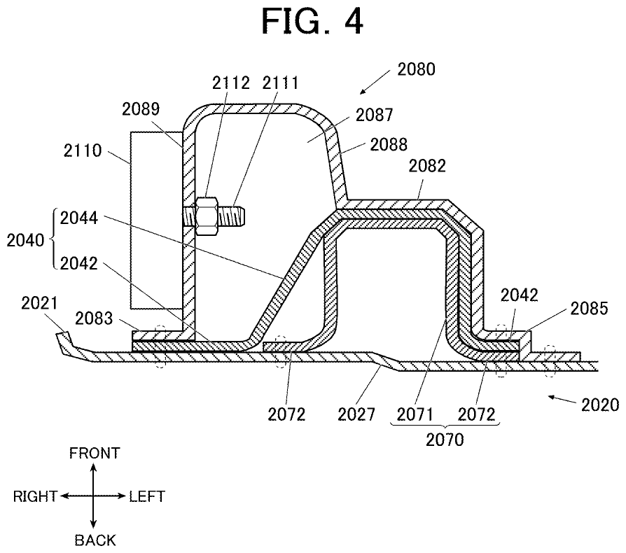

The upper frame 2040 is bonded to the panel frame 2020 in a state in which a right end is covered by the mounting bracket 2080 from the front. FIG. 2 is a perspective view of the right end of the upper frame 2040 in a state in which the mounting bracket 2080 has been removed. FIG. 3 is a cross-sectional view taken along the line C-C in FIG. 1. FIG. 4 is a cross-sectional view taken along the line B-B in FIG. 1.

The upper frame 2040 is a metallic strut formed by press-working a flat plate of steel, aluminum alloy, or the like and is arranged in the left-right direction at the upper end of the front surface of the panel frame 2020.

As illustrated in FIG. 3, the upper frame 2040 has a columnar portion 2041 shaped to have a substantially U-shaped open cross-section deformed over substantially the entire length, and a pair of flanges 2042 formed at opposite ends on the open side of the columnar portion 2041 over substantially the entire length. Each of the pair of flanges 2042 has a planar portion opposed to the panel frame 2020. The planar portion is in surface contact with the panel frame 2020 and is bonded at a plurality of locations in the long-side direction through laser welding.

Ovals indicated by broken lines in FIG. 3 are the locations bonded through laser welding. The same applies to ovals indicated by broken lines in the drawings other than FIG. 3.

At the front side of the columnar portion 2041 of the upper frame 2040, a front surface portion 2043 composed of an inclined surface inclined backward to the lower side is formed over substantially the entire length except left and right opposite ends, as illustrated in FIG. 3.

A stepped reinforcement (protruding/recessed reinforcement) 2026 implemented by a difference in level in the front-back direction is formed at a position between the two flanges 2042 of the upper frame 2040 on the panel frame 2020 (illustration is omitted in FIG. 1). This stepped reinforcement 2026 is formed in the long-side direction of the upper frame 2040. The stepped reinforcement 2026 may be formed substantially over a length as long as the entire length of the upper frame 2040.

The aforementioned parallel reinforcement 2021 is formed in parallel to the upper frame 2040 immediately below and adjacent to the upper frame 2040 on the panel frame 2020. The parallel reinforcement 2021 extends in the left-right direction within a range substantially close to the entire length of the upper frame 2040.

The two flanges 2042 of the upper frame 2040 are bonded to the panel frame 2020 with the stepped reinforcement 2026 interposed therebetween.

The rigidity at the peripheries of the stepped reinforcement 2026 and the parallel reinforcement 2021 on the panel frame 2020 is high. Improvement in bonding strength of the upper frame 2040 to the panel frame 2020 is thus accomplished.

The left end of the upper frame 2040 has a closed leading end and has a notch formed therein, an upper end of the left side frame 2060 being inserted into the notch from below as illustrated in FIG. 1. Consequently, the side frame 2060 and the upper frame 2040 are bonded to the panel frame 2020 in a state in which the left end of the upper frame 2040 is overlapped on the upper end of the side frame 2060 from the front side when viewed in the front-back direction.

In the region where the upper end of the side frame 2060 and the left end of the upper frame 2040 are overlapped, portions in surface contact with each other may be bonded through laser welding or the like.

The right end of the upper frame 2040 has a structure having a bend 2044 linked to the columnar portion 2041 and bent at 90 degrees to extend downward as illustrated in FIG. 2, and the bend 2044 covers an upper end of the right side frame 2070 from the front side to be overlapped in the front-back direction.

The right flange 2042 of the bend 2044 is projected widely to the right to ensure a wide surface bonded to the front surface of the panel frame 2020.

At the right end of the upper frame 2040, the bend 2044 having a substantially U-shaped cross-section is overlapped on the right side frame 2070 in the front-back direction as illustrated in FIG. 4. The left flange 2042, a flange 2085 of the mounting bracket 2080, and a flange 2072 of the side frame 2070 are bonded integrally to the panel frame 2020 in a state overlapped as three layers with the flange 2085 located on the front side of the left flange 2042 and the flange 2072 located on the back side of the left flange 2042.

The right flange 2042 of the upper frame 2040 and a flange 2083 of the mounting bracket 2080 are bonded to the panel frame 2020 in a state in which the flange 2083 is overlapped on the right flange 2042 on the front side.

Also in the case of the bend 2044 of the upper frame 2040, a stepped reinforcement (protruding/recessed reinforcement) 2027 implemented by a difference in level in the left-right direction is formed at a position between the two flanges 2042 of the panel frame 2020 (illustration is omitted in FIG. 1). This stepped reinforcement 2027 is also located between the two flanges 2072 of the right side frame 2070, and may thus be formed over a length as long as the entire length of the side frame 2070.

The rigidity at the periphery of the stepped reinforcement 2027 on the panel frame 2020 is increased by the stepped reinforcement 2027, and improvement in bonding strength of the bend 2044 of the upper frame 2040 to the panel frame 2020 is accomplished.

### [Lower Frame and Side Frames]

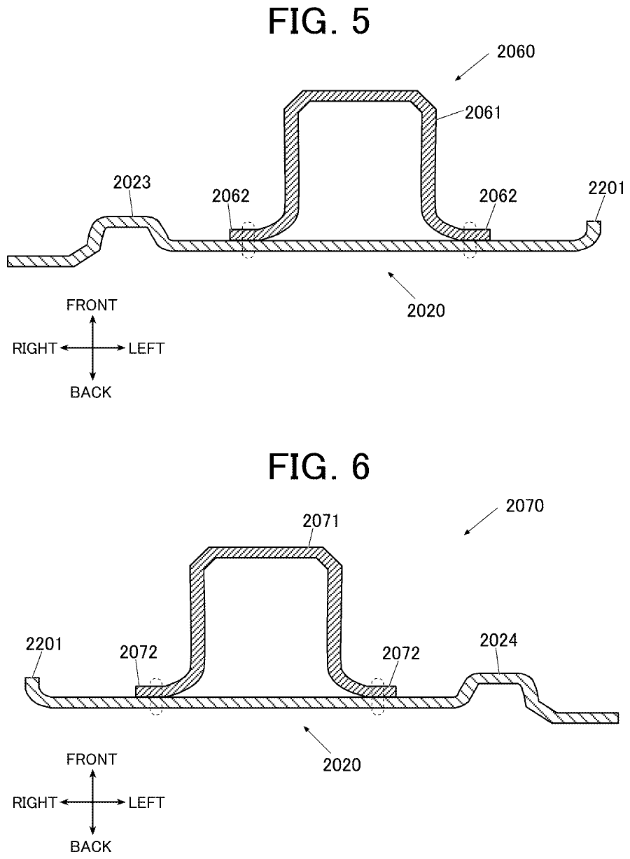

FIG. 5 is a cross-sectional view taken along the line E-E in FIG. 1. FIG. 6 is a cross-sectional view taken along the line F-F in FIG. 1. The lower frame 2050 and the left and right side frames 2060, 2070 will be described based on FIG. 1, FIG. 5, and FIG. 6.

Each of the lower frame 2050 and the left and right side frames 2060, 2070 is a metallic strut formed by press-working a flat plate of steel, aluminum alloy, or the like.

The lower frame 2050 is arranged in the left-right direction at the lower end of the front surface of the panel frame 2020.

The left side frame 2060 is arranged in the up-down direction at the left end of the front surface of the panel frame 2020.

The right side frame 2070 is arranged in the up-down direction at the right end of the front surface of the panel frame 2020.

As illustrated in FIG. 1, the lower frame 2050 has a columnar portion 2051 shaped to have a substantially U-shaped open cross-section over the entire length and a pair of flanges 2052 formed at opposite ends on the open side of the columnar portion 2051 over substantially the entire length. Each of the pair of flanges 2052 has a planar portion opposed to the panel frame 2020 and is bonded at a plurality of locations in the long-side direction through laser welding in a state in which the planar portion is in surface contact with the panel frame 2020.

The aforementioned parallel reinforcement 2022 is formed immediately above and adjacent to the lower frame 2050 on the panel frame 2020 in parallel to the lower frame 2050. The parallel reinforcement 2022 extends in the left-right direction within a range substantially close to the entire length of the lower frame 2050.

The rigidity is increased at the periphery of the parallel reinforcement 2022 on the panel frame 2020. Improvement in bonding strength of the lower frame 2050 to the panel frame 2020 is thus accomplished.

As illustrated in FIG. 5 and FIG. 6, the left and right side frames 2060, 2070 respectively have columnar portions 2061, 2071 shaped to have substantially U-shaped open cross-sections over the entire length and pairs of flanges 2062, 2072 formed at opposite ends on the open side of the columnar portions 2061, 2071 over substantially the entire length. Each of the pairs of flanges 2062, 2072 has a planar portion opposed to the panel frame 2020 and is bonded to the panel frame 2020 through laser welding at a plurality of locations in the long-side direction in a state in which the planar portion is in surface contact with the panel frame 2020.

The aforementioned parallel reinforcements 2023, 2024 are respectively formed immediately on the right of and adjacent to the left side frame 2060 and immediately on the left of and adjacent to the right side frame 2070 on the panel frame 2020 in parallel to the side frames 2060, 2070. The parallel reinforcements 2023, 2024 extend in the up-down direction within a range substantially close to the entire length of the side frames 2060, 2070.

The rigidity at the peripheries of the parallel reinforcements 2023, 2024 on the panel frame 2020 is increased. Improvement in bonding strength of the side frames 2060, 2070 to the panel frame 2020 is thus accomplished.

### [Lock Device]

A lock device 2110 is implemented by a well-known configuration.

As an example, a lock device may be employed which includes a latch that engages and disengages a striker implemented by an annular wire and a ratchet that switches between maintenance and disengagement of an engaged state of the latch by an external operation, inside a casing having a notch through which the striker is to be inserted, similarly to a latch mechanism described in JP 2015-163506A.

As illustrated in FIG. 1, the lock device 2110 is mounted on the mounting bracket 2080 in a state in which the notch of the casing is oriented backward.

By moving the panel frame structure 2100 backward relative to the striker arranged with its leading end oriented to the left behind the panel frame structure 2100 to cause the leading end of the striker to enter the notch relatively from behind, the panel frame structure 2100 is fixed in the front-back direction.

### [Mounting Bracket]

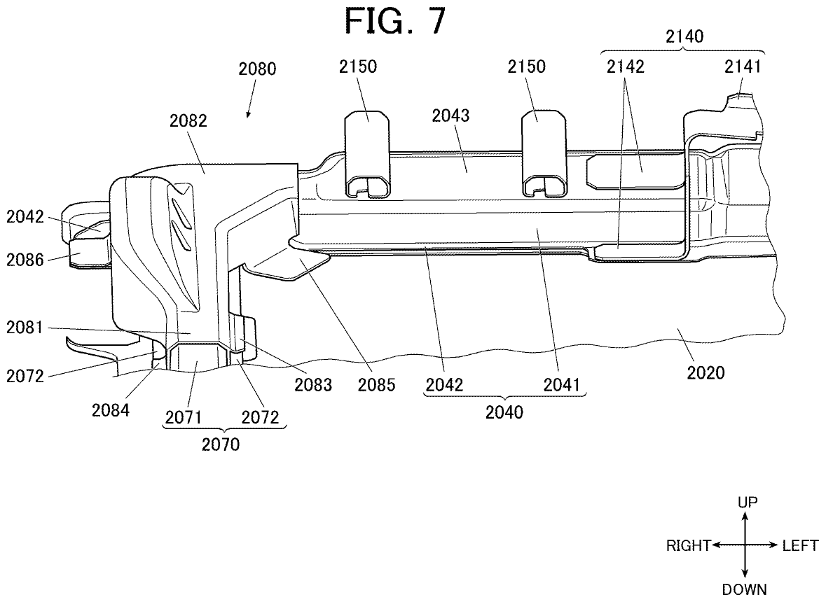

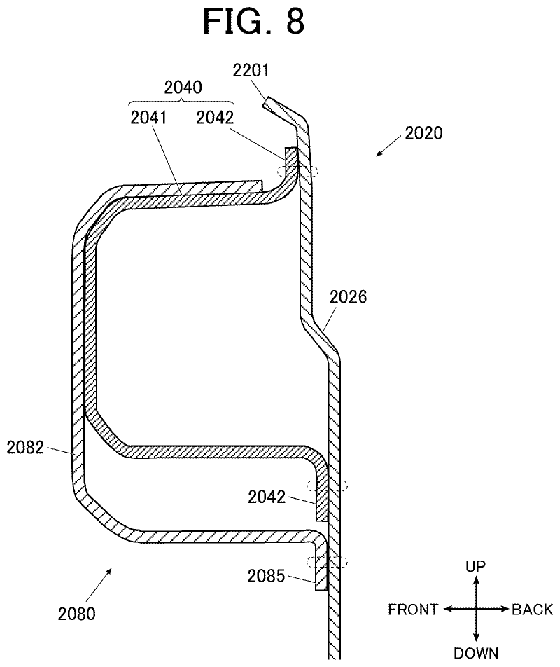

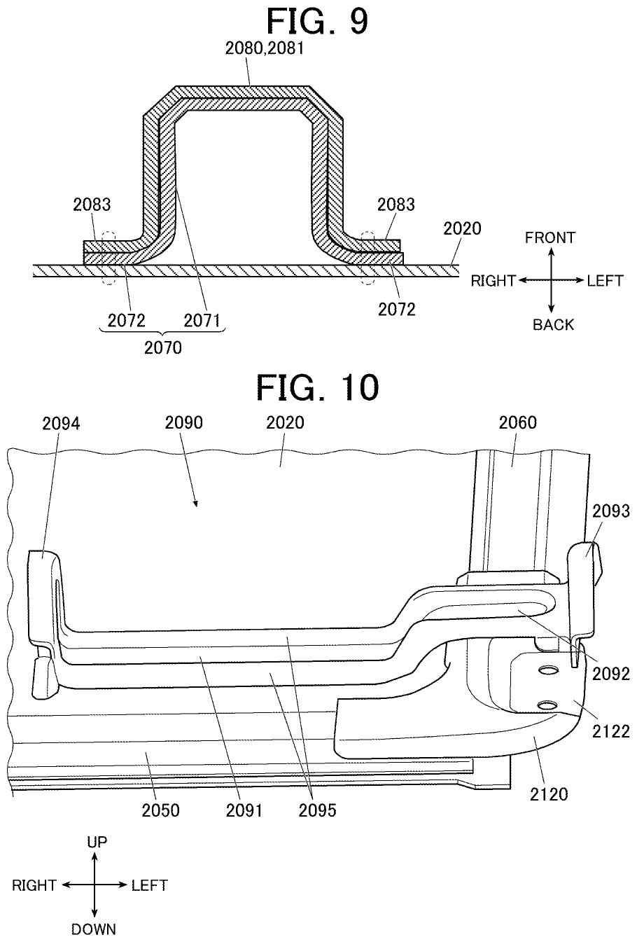

FIG. 7 is a perspective view of a right upper portion of the panel frame structure 2100. FIG. 8 is a cross-sectional view taken along the line A-A in FIG. 1. FIG. 9 is a cross-sectional view taken along the line D-D in FIG. 1.

The mounting bracket 2080 will be described based on FIG. 1, FIG. 4, and FIG. 7 to FIG. 9.

The mounting bracket 2080 is arranged at a right upper corner on the front surface of the panel frame 2020.

The mounting bracket 2080 is a metallic bracket formed by press-working a flat plate of steel, aluminum alloy, or the like.

The mounting bracket 2080 has a lower portion 2081 and an upper portion 2082.

The lower portion 2081 extends in the up-down direction to cover the entire upper portion of the right side frame 2070. The upper portion 2082 is bent from an upper end of the lower portion 2081 and extends to the left to cover the right end of the upper frame 2040.

The lower portion 2081 and the upper portion 2082 of the mounting bracket 2080 are shaped to have substantially U-shaped open cross-sections over substantially the entire lengths in their extending directions, and openings of the open cross-sections are oriented toward the panel frame 2020.

As illustrated in FIG. 9, the mounting bracket 2080 has flanges 2083, 2084 projected from the lower portion 2081 to the left and right.

In the mounting bracket 2080, the region of the lower portion 2081 shaped to have the open cross-section and the left and right flanges 2083, 2084 are overlapped on the columnar portion 2071 and the left and right flanges 2072 of the right side frame 2070 from the front.

The overlapped portion of the flange 2083 and the flange 2072 and the overlapped portion of the flange 2084 and the flange 2072 are bonded integrally to the panel frame 2020 through laser welding in the overlapped state.

The back surface of the region of the lower portion 2081 shaped to have the open cross-section and the front surface of the columnar portion 2071 of the right side frame 2070 may be bonded at portions in surface contact.

As illustrated in FIG. 7 and FIG. 8, the mounting bracket 2080 has flanges 2085, 2086 respectively projected in a left lower direction and to the right from the upper portion 2082.

In the mounting bracket 2080, the region of the upper portion 2082 shaped to have the open cross-section and the flange 2086 are overlapped on the bend 2044 and the flange 2042 of the upper frame 2040 from the front.

The overlapped portion of the flange 2086 and the flange 2042 is bonded integrally to the panel frame 2020 in the overlapped state.

The overlapped portion of the mounting bracket 2080 and the upper frame 2040 other than the above may also be bonded.

As illustrated in FIG. 4, the upper portion 2082 of the mounting bracket 2080 is overlapped on the columnar portion 2071 of the side frame 2070 and the bend 2044 of the upper frame 2040 in the front-back direction.

The above-described three-layer overlapped portion may be bonded integrally at any location.

The flange 2085 of the mounting bracket 2080 is overlapped on the flange 2072 of the side frame 2070 and the flange 2042 of the upper frame 2040 in the front-back direction.

The above-described three-layer overlapped portion is bonded integrally to the panel frame 2020.

The flange 2085 is extended to the left relative to the flanges 2072, 2042 and has its leading end bonded to the panel frame 2020 independently.

As illustrated in FIG. 4, the mounting bracket 2080 has a bulging portion 2088 that forms a clearance space 2087 in conjunction with the upper frame 2040. The bulging portion 2088 bulges forward from the front surfaces of the right ends of the lower portion 2081 and the upper portion 2082. The bulging portion 2088 thus ensures a wide sidewall 2089 which is flat at the right side, and an outer surface (a right side surface) of the sidewall 2089 serves as a mounting surface for the lock device 2110.

The lock device 2110 is mounted on the mounting surface of the mounting bracket 2080 fixedly with a bolt 2111 and a nut 2112 which are fasteners. The clearance space 2087 of the mounting bracket 2080 is utilized as space for storing the nut 2112. The nut 2112 is fixed to an inner surface of the sidewall 2089 in the clearance space 2087 through bonding or the like.

A plurality of the bolts 2111 and the nuts 2112 which are fasteners may be provided.

### [Corner Brackets]

The left and right corner brackets 2120, 2130 will be described based on FIG. 1.

The left corner bracket 2120 is arranged at a left lower corner on the front surface of the panel frame 2020. The right corner bracket 2130 is arranged at a right lower corner on the front surface of the panel frame 2020.

Each of the corner brackets 2120, 2130 is a metallic bracket formed by press-working a flat plate of steel, aluminum alloy, or the like.

The left corner bracket 2120 has an upper portion and a lower portion. The upper portion is extended upward to cover the lower end of the left side frame 2060 from the front. The lower portion is extended to the right to cover the left end of the lower frame 2050 from the front. Portions of the corner bracket 2120 overlapped on the side frame 2060 and the lower frame 2050 may be bonded to the side frame 2060 and the lower frame 2050, respectively.

The upper portion and the lower portion of the corner bracket 2120 are integrated to present an elbow shape.

Each of the upper portion and the lower portion of the corner bracket 2120 is shaped to have a substantially U-shaped open cross-section over substantially the entire length in the extending direction and has an opening of the open cross-section oriented toward the panel frame 2020.

The left corner bracket 2120 has a flange 2121 projected to the inner side of the corner. The flange 2121 has a flat plate-shape and is bonded to the front surface of the panel frame 2020.

The corner bracket 2120 also has a flange 2122 having a flat plate-shape at the left side of the corner. This flange 2122 has formed therein a mounting hole (see FIG. 10) for mounting the panel frame structure 2100 on a vehicle.

The right corner bracket 2130 has an upper portion and a lower portion. The upper portion is extended upward to cover the lower end of the right side frame 2070 from the front. The lower portion is extended to the left to cover the right end of the lower frame 2050 from the front. Portions of the corner bracket 2130 overlapped on the side frame 2070 and the lower frame 2050 may be bonded to the side frame 2070 and the lower frame 2050, respectively.

The upper portion and the lower portion of the corner bracket 2130 are integrated to present an elbow shape.

Each of the upper portion and the lower portion of the corner bracket 2130 is shaped to have a substantially U-shaped open cross-section over substantially the entire length in the extending direction and has an opening of the open cross-sections oriented toward the panel frame 2020.

The right corner bracket 2130 has a flange 2131 projected to the inner side at the corner. The flange 2131 has a flat plate-shape and is bonded to the front surface of the panel frame 2020.

The corner bracket 2130 also has a flange 2132 projected to the left side of the corner and having a flat plate-shape. This flange 2132 has formed therein a mounting hole not illustrated for mounting the panel frame structure 2100 on the vehicle.

### [Armrest Bracket]

JP 2020-079062A discloses a panel frame structure including a support bracket for an armrest.

As described in the above-described gazette, a panel-like fixation patch having protrusions and recesses formed in conformity to a protruding/recessed shape of a panel frame has conventionally been bonded to a range of the panel frame on which the support bracket is to be mounted. The support bracket is then mounted on the panel frame with the fixation patch interposed therebetween.

However, the above-described conventional panel frame structure requires skirting of the panel-like fixation patch in a case in which members other than the support bracket are mounted on the panel frame because of the structure in which the support bracket for the armrest is mounted with the interposition of the fixation patch. This raises a problem in that the entire panel frame structure is increased in size.

An object of the following armrest bracket mounting structure, which has been conceived in light of the circumstances described above, is to accomplish size reduction of a panel frame structure.

An invention of the first solution for solving the above problems is a panel frame structure comprising:
a panel frame;
an upper frame bonded along an upper end of the panel frame;
a side frame bonded along a lateral end of the panel frame;
an armrest bracket that supports the armrest; and
a corner bracket to be bonded to a corner of the panel frame,
wherein the armrest bracket has a portion overlapped on the side frame or the corner bracket when viewed in a front-back direction.

An invention of the second solution is the first solution,
wherein the armrest bracket is bonded to the side frame or the corner bracket.

An invention of the third solution is the first solution,
wherein the armrest bracket is bonded to neither the side frame nor the corner bracket.

An invention of the fourth solution is any one of the first solution to the third solution,
wherein the armrest bracket has a shape skirting the side frame or the corner bracket in the front-back direction.

FIG. 10 is a magnified perspective view of a left lower portion of the panel frame structure 2100.

Concerning the armrest bracket 2090 and its mounting structure, the substance of the above-described solutions will be described specifically based on FIG. 10.

The armrest bracket 2090 is arranged slightly above the corner bracket 2120 at the left lower corner on the front surface of the panel frame 2020.

The armrest bracket 2090 is a metallic bracket formed by press-working a flat plate of steel, aluminum alloy, or the like.

The armrest bracket 2090 has a main body 2091, a bypass portion 2092, and a pair of arms 2093, 2094.

The main body 2091 is long in the left-right direction and has a back surface bonded to the front surface of the panel frame 2020. The main body 2091 has formed thereon a pair of upper and lower reinforcements 2095 implemented by beads extending in the long-side direction.

Each of the reinforcements 2095 is a ridge protruding forward on the front surface of a flat surface of the armrest bracket 2090 and recessed forward in the back surface.

The bypass portion 2092 is overlapped on the lower end of the side frame 2060 and the corner bracket 2120 in the front-back direction at the left of a left end of the main body 2091. The bypass portion 2092 is angled like a crank for bypass from the left end of the main body 2091 to the front sides of the side frame 2060 and the corner bracket 2120.

The bypass portion 2092 may or may not be bonded to the front surface of the corner bracket 2120 in the region overlapped on the corner bracket 2120 in the front-back direction.

The two bead-like reinforcements 2095 formed on the main body 2091 are formed to be extended to the vicinity of a left end of the bypass portion 2092.

The left arm 2093 is bent from the left end of the bypass portion 2092 to be extended forward. The right arm 2094 is bent from the right end of the main body 2091 to be extended forward.

The left and right arms 2093, 2094 have formed therein through-holes which are concentric when viewed in the left-right direction. These through-holes are intended to support a base end of the armrest not illustrated so as to be rotatable around an axis in the left-right direction.

### [Belt Guide]

The belt guide 2140 will be described based on FIG. 1.

A retractor not illustrated, from which the seat belt is to be pulled out, is placed at a central portion of the front surface of the panel frame 2020. The belt guide 2140 is arranged above the retractor at a central portion of the upper end on the front surface of the panel frame 2020.

The belt guide 2140 is a member for guiding the seat belt pulled out from the lower retractor to be passed from below and folded back downward.

The belt guide 2140 is formed by press-working a flat plate of steel, aluminum alloy, or the like.

The belt guide 2140 has an insertion portion 2141 through which the seat belt is to be passed, and four legs 2142.

The insertion portion 2141 is shaped to have a substantially U-shaped open cross-section in the up-down direction and has an opening of the open cross-section oriented toward the panel frame 2020. The insertion portion 2141 allows insertion of the seat belt upward from below.

The legs 2142 include legs extended from an upper end of the insertion portion 2141 to the left and right, respectively, and legs extended from a lower end of the insertion portion 2141 to the left and right, respectively.

The upper two legs 2142 have back surfaces bonded to the front surface portion 2043 of the upper frame 2040.

The lower two legs 2142 have back surfaces bonded to the front surface of the panel frame 2020.

As described above, the upper side and the lower side of the belt guide 2140 are fixed to different members.

### [Headrest Supports]

The headrest supports 2150 are bonded to be aligned in a row to the left and right at a total of four locations, two locations on the left side and two locations on the right side of the belt guide 2140, on the front surface portion 2043 of the upper frame 2040 as illustrated in FIG. 1 and FIG. 2.

The headrest supports 2150 in pairs support a headrest not illustrated.

Each of the supports 2150 is a substantially rectangular cylindrical member obtained by bending a metal plate and is mounted on the front surface portion 2043 of the upper frame 2040 in the orientation in the up-down direction.

The headrest includes a pair of left and right pillars. The headrest is supported in a state in which the respective pillars are inserted into the inner side of two of the supports 2150 from above.

### Technical Effects of Embodiment of Invention

In the above-described panel frame structure 2100, the mounting bracket 2080 has the portions overlapped on the upper frame 2040 when viewed in the front-back direction. High rigidity is thus obtained at the overlapped portions of the mounting bracket 2080 and the upper frame 2040, which accomplishes improvement in strength of the panel frame structure 2100.

The above-described overlapped portions may be bonded to each other.

The panel frame structure 2100 is in the state in which the mounting bracket 2080 covers at least part of the upper frame 2040. High rigidity is thus obtained at the portion where the mounting bracket 2080 covers the upper frame 2040, which accomplishes improvement in strength of the panel frame structure.

In the panel frame structure 2100, the side frame 2070, the mounting bracket 2080, and the upper frame 2040 have overlapped portions when viewed in the front-back direction. Higher rigidity is thus obtained at their overlapped portions, which accomplishes further improvement in strength of the panel frame structure 2100.

The above-described three-layer overlapped portions may be bonded integrally.

The panel frame structure 2100 has the clearance space 2087 in which the nut 2112 is arranged, between the mounting bracket 2080 and the upper frame 2040. The nut 2112 is thus arranged without protruding from the surface of the panel frame structure 2100. The utilization of the clearance space 2087 also accomplishes size reduction and compactification of the periphery of the mounting bracket 2080.

The bolt 2111 may be arranged in the clearance space 2087 so that a screw shaft of the bolt 2111 protrudes to the outside of the mounting bracket 2080. In that case, the bolt 2111 is fastened with the nut 2112 on the outside to fix the lock device 2110. In this case, the bolt 2111 may be bonded to an inner wall of the mounting bracket 2080.

In the panel frame structure 2100, the nut 2112 is bonded to the inner surface side of the sidewall 2089 of the bulging portion 2088. This eliminates the need to press the nut 2112 when the lock device 2110 is mounted, which accomplishes facilitation of an assembling work.

In the panel frame structure 2100, the mounting bracket 2080 has the clearance space 2087 on the inner side of the bulging portion 2088 protruding in the front-back direction. The mounting surface for the lock device 2110 is thus ensured widely in the front-back direction. The lock device 2110 is thus mounted stably and with high strength.

In the panel frame structure 2100, the mounting bracket 2080 is bonded separately to the upper frame 2040, the side frame 2070, and the panel frame 2020. A load is thus distributed to the panel frame 2020, the upper frame 2040, and the side frame 2070 if an external force is applied to the lock device 2110, and the mounting strength of the lock device 2110 is maintained high. Deflection of the panel frame structure 2100 under the external force applied to the lock device 2110 is also prevented.

In the panel frame structure 2100, the armrest bracket 2090 has the portion overlapped on the side frame 2060 or the corner bracket 2120 when viewed in the front-back direction. This eliminates the need to arrange the armrest bracket 2090 to skirt the side frame 2060 or the corner bracket 2120, which accomplishes size reduction of the panel frame structure 2100.

High rigidity is obtained at the overlapped portion of the armrest bracket 2090 and the side frame 2060 or the corner bracket 2120, which accomplishes improvement in strength of the panel frame structure 2100.

In the case in which the armrest bracket 2090 is bonded to the side frame 2060 or the corner bracket 2120 on the panel frame structure 2100, improvement in mounting strength is accomplished.

In a case in which the armrest bracket 2090 is not bonded to the side frame 2060 or the corner bracket 2120, room for allowing deflection of the portion of the armrest bracket 2090 overlapped on the side frame 2060 or the corner bracket 2120 is left. Consequently, a load applied to the armrest is absorbed to prevent occurrence of breakage, deformation, damage, or the like.

In the armrest bracket 2090, the bypass portion 2092 is shaped to skirt the side frame 2060 or the corner bracket 2120 in the front-back direction. Bending of the skirting shape of the bypass portion 2092 thus increases the rigidity of the armrest bracket 2090. The armrest bracket 2090 skirts the side frame 2060 or the corner bracket 2120 while being bonded to the panel frame 2020, and the armrest bracket 2090 is mounted with high strength.

The panel frame structure 2100 has the stepped reinforcements 2026, 2027 at positions to be the inner side of the opening of the open cross-section of the upper frame 2040 on the panel frame 2020. The upper frame 2040 is thus bonded to the portions increased in rigidity by the stepped reinforcements 2026, 2027 on the panel frame 2020, and the bonding strength of the upper frame 2040 is increased.

The panel frame structure 2100 has the parallel reinforcements 2021 to 2024 respectively aligned with the outside of the openings of the open cross-sections of the upper frame 2040, the side frames 2060, 2070, and the lower frame 2050 on the panel frame 2020. The upper frame 2040, the side frames 2060, 2070, and the lower frame 2050 is thus bonded to the peripheries of the portions increased in rigidity by the parallel reinforcements 2021 to 2024, and the bonding strength of the upper frame 2040, the side frames 2060, 2070, and the lower frame 2050 is increased.

In the panel frame structure 2100, the central reinforcement 2025 implemented by the netted bead is formed on the panel frame 2020. The rigidity of the panel frame 2020 against a load in the direction vertical to the plane of the panel frame 2020 is thus increased, and improvement in strength of the entire panel frame structure 2100 is accomplished.

### [Another Form of Belt Guide]

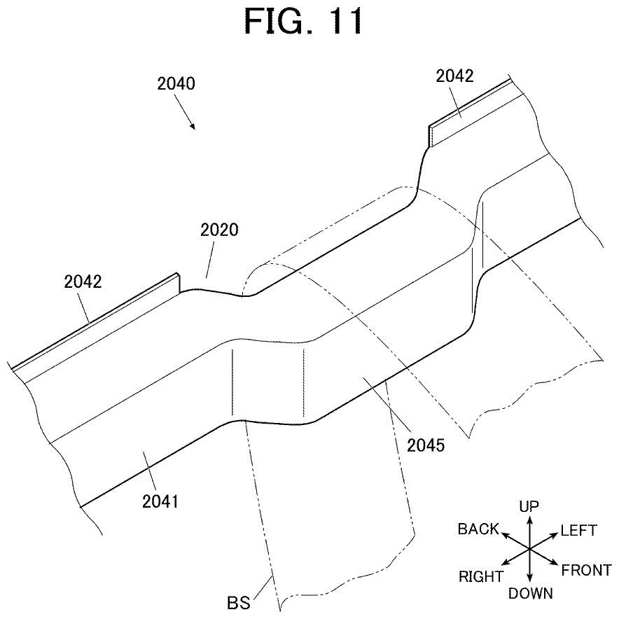

Instead of the aforementioned belt guide 2140, the upper frame 2040 may be provided with a guide 2045 that functions equivalently to the belt guide 2140. FIG. 11 is a perspective view of the upper frame 2040 having the guide 2045.

As illustrated, the guide 2045 of the upper frame 2040 is formed in a bent manner such that only a middle portion in the long-side direction of the columnar portion 2041 is spaced forward from the front surface of the panel frame 2020. A seat belt BS is passed and guided through the clearance formed by the guide 2045 in conjunction with the panel frame 2020.

This guide 2045 eliminates the need for the belt guide 2140.

The flanges 2042 may not be provided at a portion of the upper frame 2040 in the long-side direction that corresponds to the guide 2045.

Corners of the guide 2045 to be brought into contact with the seat belt BS may be rounded to help the seat belt BS slide.

### [Another Form of Mounting Bracket]

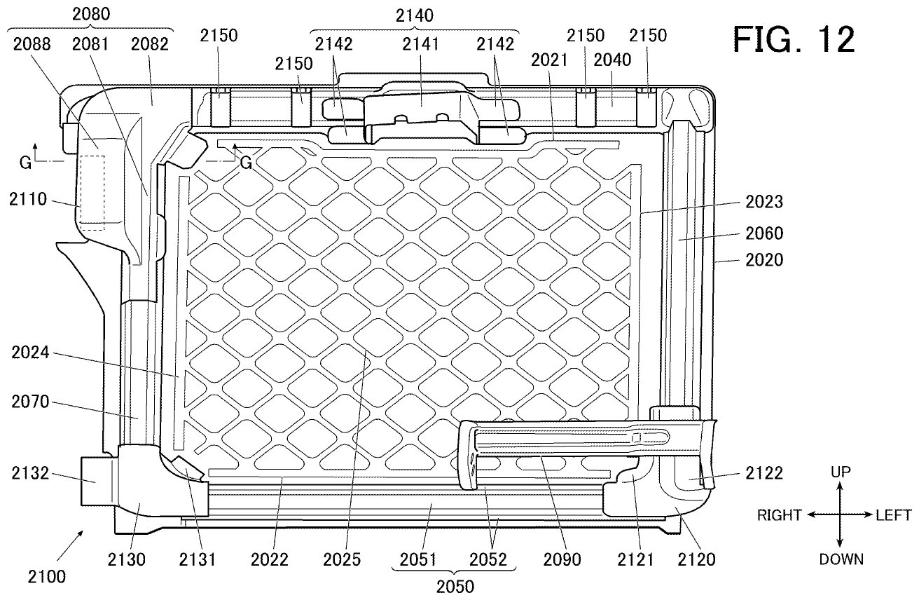

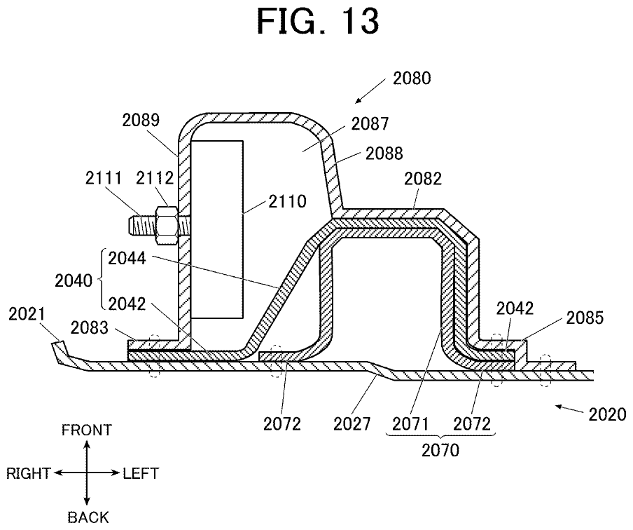

FIG. 12 is a front view showing the front surface side of the panel frame structure 2100 including the mounting bracket 2080 in another form. FIG. 13 is a cross-sectional view taken along the line G-G in FIG. 12.

Although the mounting bracket 2080 in FIG. 1 is configured such that the lock device 2110 is mounted on the right side surface on the outside, the present invention is not limited to this.

In the mounting bracket 2080 illustrated in FIG. 12 and FIG. 13, the bulging portion 2088 has a greater width in the left-right direction than in the mounting bracket 2080 in FIG. 1 to increase the capacity of the clearance space 2087.

The mounting bracket 2080 thus stores and arranges the lock device 2110 in the clearance space 2087.

In the case of the above-described configuration, a member (for example, the striker) to be held fixedly on the lock device 2110 needs to make access to the lock device 2110 on the inner side of the mounting bracket 2080. For example, a notch or an opening through which the member such as the striker is to enter the inside is preferably provided in the right side surface of the mounting bracket 2080.

Although FIG. 13 exemplifies the mounting bracket 2080 with the nut 2112 which is a fastener arranged on the outside of the mounting bracket 2080, (the head of) the bolt 2111 may be arranged on the outside of the mounting bracket 2080.

Since the above-described configuration has the clearance space 2087 that stores the lock device 2110, between the mounting bracket 2080 and the upper frame 2040, the lock device 2110 is protected from the outside. The lock device 2110 is arranged without protruding from the surface of the panel frame structure 2100. The utilization of the clearance space 2087 also accomplishes size reduction and compactification of the periphery of the lock device 2110.

### [Diversion of Mounting Bracket to Airbag Module]

JP 2015-163506A discloses an example in which a mounting bracket for mounting a unit having a specific function on a conveyance seat is deployed on a side frame of a seat frame.

However, the above-described conventional panel frame structure has room for improvement in strength of the structure. Particularly in a case in which the functional unit is an airbag module, sufficient strength is required of the panel frame structure in order to cause the airbag to function effectively.

An object of the following panel frame structure, which has been conceived in light of the circumstances described above, is to accomplish improvement in strength of the panel frame structure.

An invention of the first solution for solving the above problem is a panel frame structure comprising:
a panel frame;
an upper frame bonded along an upper end of the panel frame;
a side frame bonded along a lateral end of the panel frame; and
a mounting bracket for an airbag module,
wherein the mounting bracket has a portion overlapped on the upper frame when viewed in the front-back direction.

An invention of the second solution is the first solution,
wherein the mounting bracket is in a state covering at least part of the upper frame.

An invention of the third solution is the first or second solution,
wherein the side frame, the mounting bracket, and the upper frame have overlapped portions when viewed in the front-back direction.

An invention of the fourth solution is the first solution,
wherein a clearance space in which a fastener for mounting the airbag module is arranged is provided between the mounting bracket and the upper frame.

An invention of the fifth solution is the fourth solution,
wherein the fastener is bonded to an inner surface side of a sidewall that forms the clearance space.

An invention of the sixth solution is the fourth or fifth solution,
wherein the mounting bracket has the clearance space on an inner side of a region protruding in the front-back direction.

An invention of the seventh solution is the third solution,
wherein the mounting bracket is bonded to at least one of the upper frame or the side frame and to the panel frame.

An invention of the eighth solution is any one of first to seventh solutions,
wherein the panel frame has a flange on an outer edge portion, the flange being opposed to the airbag module mounted on the mounting bracket.

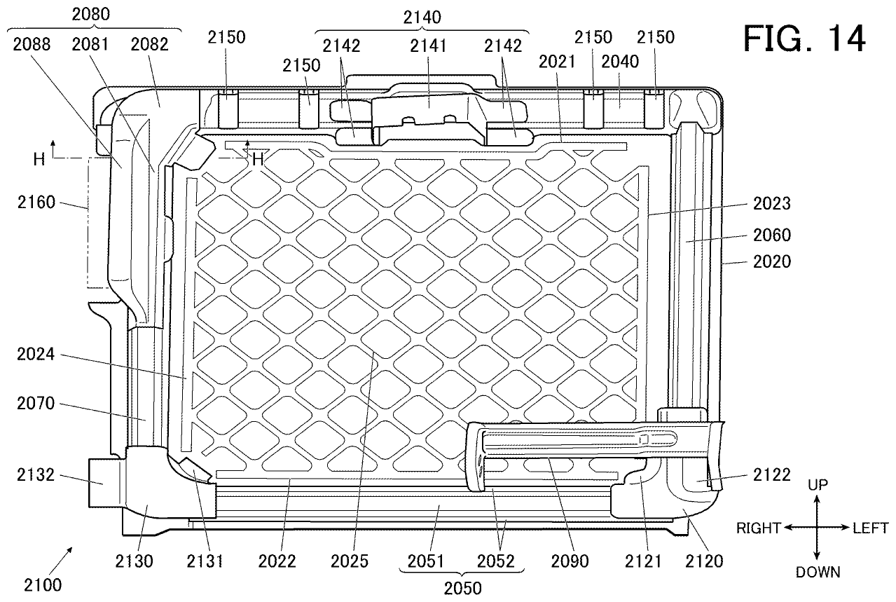

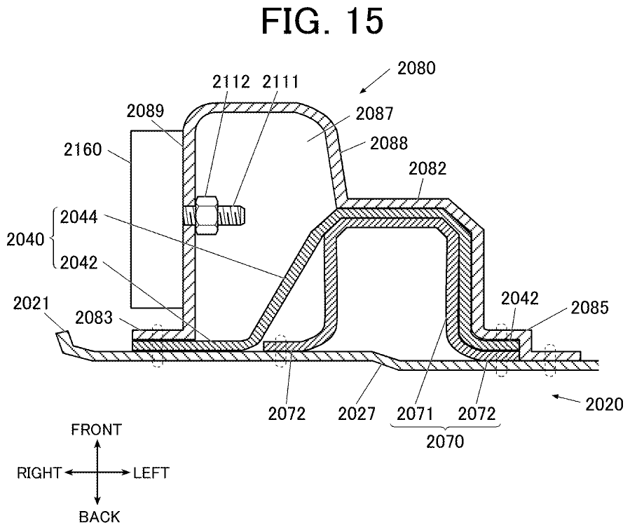

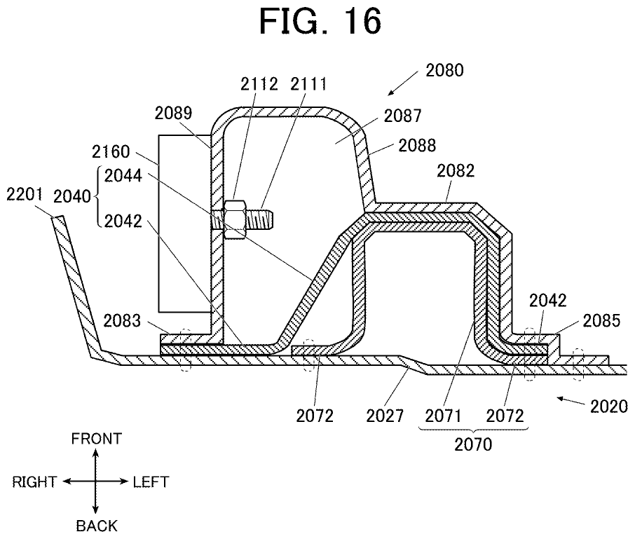

FIG. 14 is a front view of the panel frame structure 2100 in a case in which the mounting bracket 2080 is diverted to an airbag module 2160. FIG. 15 is a cross-sectional view taken along the line H-H in FIG. 14. FIG. 16 is a cross-sectional view taken along the line H-H in FIG. 14 in an example in which the flange 2201 has been refined.

Concerning the above-described panel frame structure 2100, the substance of the above-described solutions will be described specifically based on FIG. 14 to FIG. 16.

The airbag module 2160 has a function of, when an impact is applied, letting out and inflating an airbag ahead of the panel frame structure 2100.

The airbag module 2160 has a larger dimension in the up-down direction than the dimension of the aforementioned lock device 2110. Thus, the mounting bracket 2080 for holding the airbag module 2160 also has a larger dimension in the up-down direction than the dimension of the mounting bracket 2080 for the lock device.

The number of the bolts 2111 and the nuts 2112 which are fasteners may be larger than in the case of the lock device 2110.

As illustrated in FIG. 15, the bulging portion 2088 of the mounting bracket 2080 is also formed longer in the up-down direction, and the outer surface of the sidewall 2089 on which the airbag module 2160 is to be mounted is also formed longer in the up-down direction.

The airbag module 2160 is mounted on the right side surface on the outside of the bulging portion 2088. The nut 2112 which is the fastener is arranged in the clearance space in the bulging portion 2088 and bonded to the inner surface of the sidewall 2089. However, a configuration may be adopted in which the nut 2112 is arranged in the clearance space in the bulging portion 2088 and bonded to the inner surface of the sidewall 2089.

As described above, the mounting bracket 2080 is identical to the mounting bracket 2080 illustrated in FIG. 1 except being formed longer in the up-down direction and extended to a lower side. The panel frame structure 2100 illustrated in FIG. 14 is identical to the panel frame structure 2100 illustrated in FIG. 1 in terms of components other than the above-described mounting bracket 2080.

As illustrated in FIG. 16, at least a range of the flange 2201 of the panel frame 2020 on the right of, adjacent to, and proximate to the airbag module 2160 may be extended forward to a degree to be opposed to the airbag module 2160. Although the illustrated example shows an example in which the flange 2201 is extended to approximately a half of the airbag module 2160 in the front-back direction, the flange 2201 may be extended to approximately the same position as the airbag module 2160 in the front-back direction.

With the above-described configuration, the mounting bracket 2080 for the airbag module 2160 has the portions overlapped on the upper frame 2040 when viewed in the front-back direction. High rigidity is thus obtained at the overlapped portions of the mounting bracket 2080 and the upper frame 2040, which accomplishes improvement in strength of the panel frame structure 2100.

With the above-described configuration, the mounting bracket 2080 is in the state covering at least part of the upper frame 2040. High rigidity is thus obtained at the portion where the mounting bracket 2080 covers the upper frame 2040, which accomplishes improvement in strength of the panel frame structure 2100.

With the above-described configuration, the side frame 2070, the mounting bracket 2080, and the upper frame 2040 have overlapped portions when viewed in the front-back direction. Higher rigidity is thus obtained at their overlapped portions, which accomplishes further improvement in strength of the panel frame structure 2100.

The above-described configuration has the clearance space 2087 in which the nut 2112 for mounting the airbag module 2160 is arranged, between the mounting bracket 2080 for the airbag module 2160 and the upper frame 2040. The nut 2112 is thus arranged without protruding from the surface of the panel frame structure 2100. The utilization of the clearance space 2087 also accomplishes size reduction and compactification of the periphery of the mounting bracket 2080.

With the above-described configuration, the nut 2112 is bonded to the inner surface side of the sidewall 2089 that forms the clearance space 2087. This eliminates the need to press the nut 2112 when the airbag module 2160 is mounted, which accomplishes facilitation of the assembling work.

With the above-described configuration, the mounting bracket 2080 has the clearance space 2087 on the inner side of the bulging portion 2088 protruding in the front-back direction. The mounting surface for the airbag module 2160 is thus ensured widely in the front-back direction. The airbag module 2160 is thus mounted stably and with high strength.

With the above-described configuration, the mounting bracket 2080 is bonded separately to the upper frame 2040, the side frame 2070, and the panel frame 2020. A load is thus distributed to the panel frame 2020, the upper frame 2040, and the side frame 2070 if an external force is applied to the airbag module 2160, and the mounting strength of the airbag module 2160 is maintained high. Deflection of the panel frame structure 2100 under the external force applied to the airbag module 2160 is also prevented.

With the above-described configuration, the panel frame 2020 has the flange 2201 opposed to the airbag module 2160 at the outer edge portion. The airbag module 2160 is thus protected from the outside, and the airbag module 2160 is actuated more stably even in case of emergency.

### [Others]

The embodiments of the present invention have been described above. However, the present invention is not limited to the above-described embodiments. For example, a constituent element formed integrally by a single member in the embodiments may be replaced by a constituent element divided into a plurality of members coupled or secured to each other. A constituent element composed of a plurality of coupled members may be replaced by a constituent element formed integrally by a single member. Besides, the details shown in the embodiments can be changed as appropriate without departing from the spirit of the invention.

As an embodiment of the invention, the panel frame structure 2100 provided with two pairs of the headrest supports 2150 and intended to be used for a laterally-wide two-person bench seat has been exemplified. However, the technical characteristics of the panel frame structure 2100 may be applied to a panel frame structure provided with a single pair of the supports 2150 to reduce the lateral width to be used for a one-person seat.

Similarly, the technical characteristics of the panel frame structure 2100 may be applied to a panel frame structure provided with more than two pairs of the supports 2150 to increase the lateral width to be used for a seat for more than two persons.

The panel frame structure 2100 having a substantially rectangular shape has been exemplified, but may have a substantially square shape.

### <2> Embodiment Related to Cushion Frame Structure of Conveyance Seat

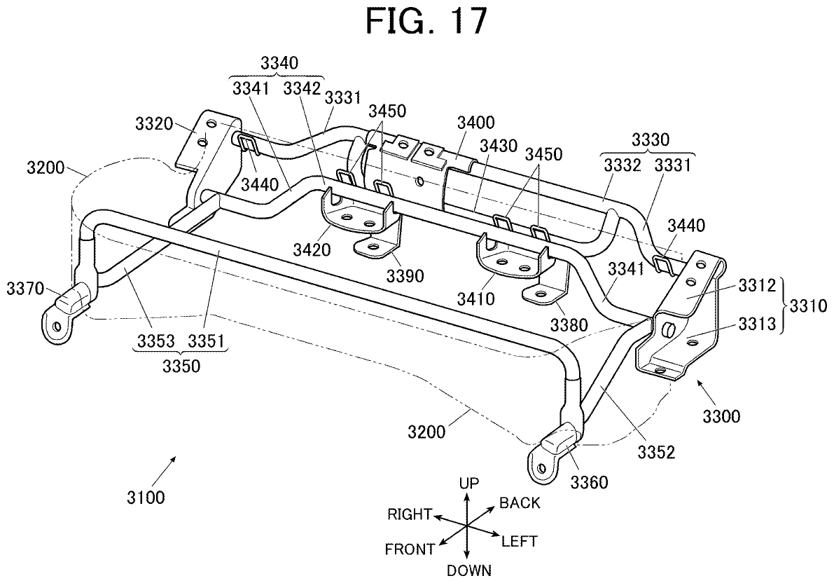

An embodiment related to a cushion frame structure of a conveyance seat will be described based on FIG. 17 to FIG. 23.

Technically preferable various limitations will be imposed on the following embodiment in order to carry out the present invention, but are not intended to limit the scope of the present invention to the following embodiment and illustrated examples.

The present embodiment is a cushion frame structure of a conveyance seat.

Although a conveyance provided with a conveyance seat to which the cushion frame structure which will be described below is applied include every conveyance that accommodates a human being and moves, such as a vessel, a flight vehicle, or a vehicle, the present embodiment exemplifies a case in which the cushion frame structure is applied to a seat of a vehicle, particularly an automobile.

The seat frame of the conveyance seat includes a cushion frame structure that forms a skeleton of a seat cushion that supports thighs and hips of a person, a seat back frame that forms a skeleton of a seat back serving as a backrest, and a recliner mechanism that moves the seat back frame in an inclined manner relative to the cushion frame structure, neither illustrated.

A cushion pad is then provided on the cushion frame structure and the seat back frame. The cushion pad is covered with a surface skin to constitute the conveyance seat.

Although not illustrated, the seat frame is placed on a floor of a vehicle body with a pair of left and right front-back slide rails interposed therebetween, the slide rails being intended for sliding (adjusting the position of) the seat frame in the front-back direction of the vehicle body.

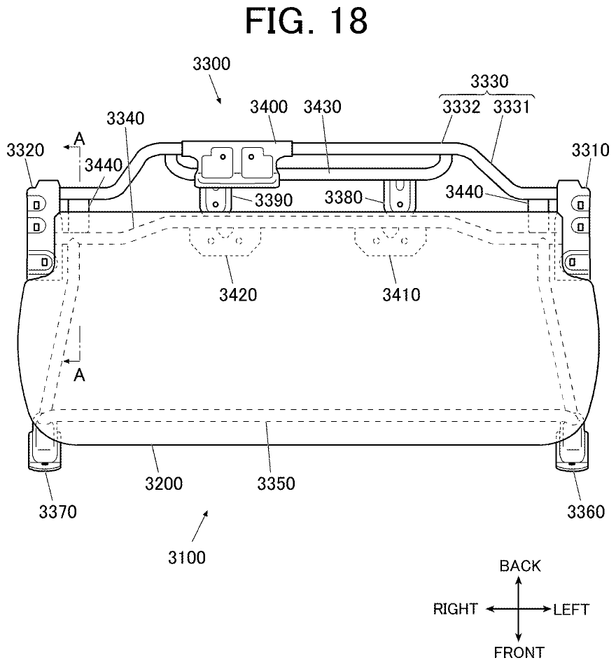

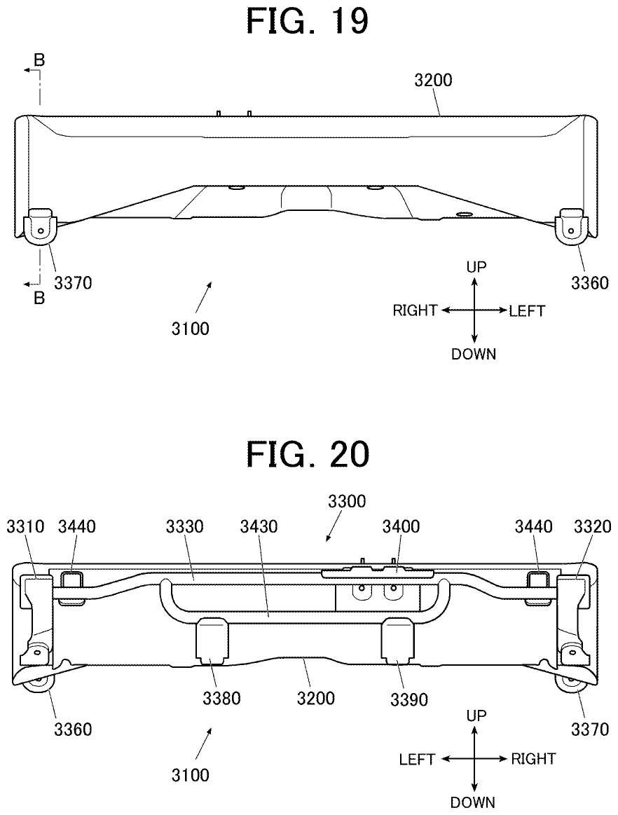

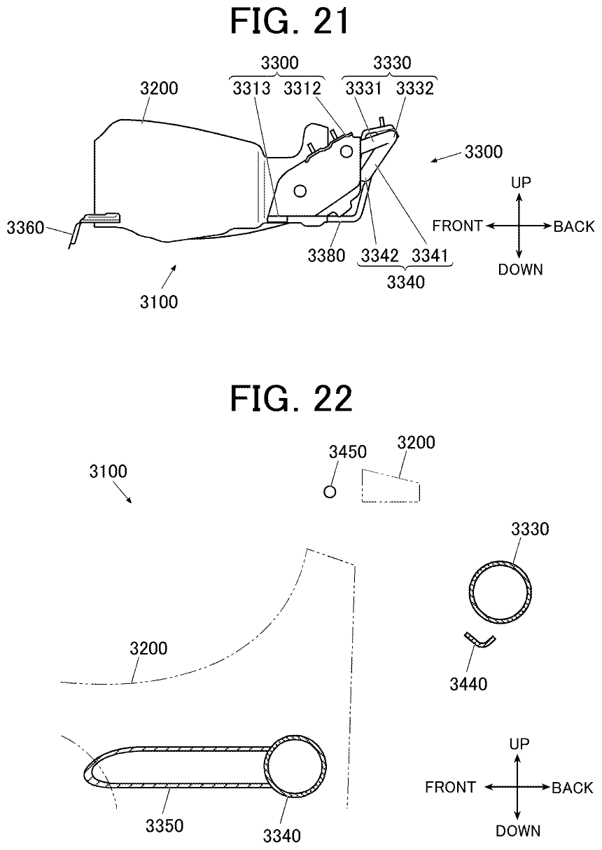

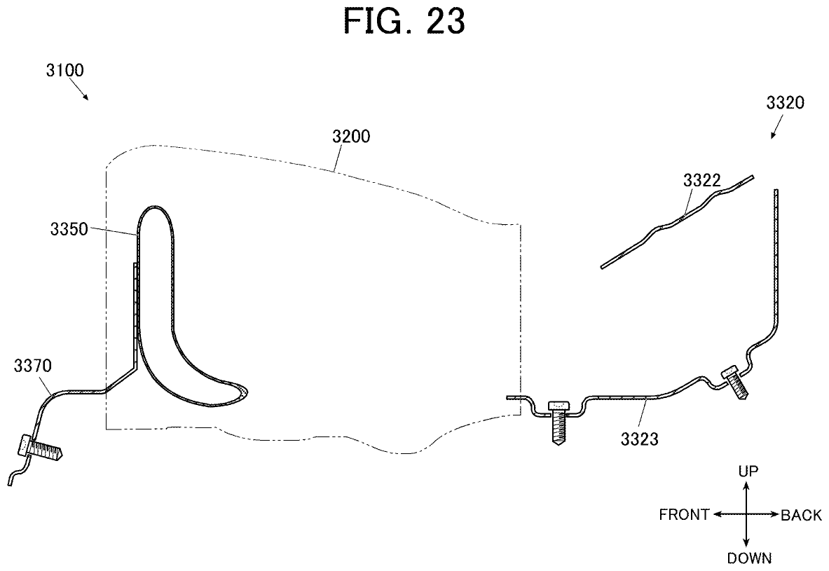

FIG. 17 is a perspective view of a cushion frame structure 3100. FIG. 18 is a plan view. FIG. 19 is a front view. FIG. 20 is a rear view. FIG. 21 is a left side view. FIG. 22 is a cross-sectional view taken along the line A-A in FIG. 18. FIG. 23 is a cross-sectional view taken along the line B-B in FIG. 19.

In each of the drawings shown in the present embodiment, up, down, left, right, front, and back directions respectively indicate directions in a state in which the cushion frame structure 3100 is mounted on the vehicle. Hereinafter, each part of the cushion frame structure 3100 will be described based on the directions in the above-described mounted state. In each of the drawings, the front side of an occupant of a conveyance seat having the cushion frame structure 3100 indicates the “front”, the opposite side thereof indicates the “back”, and the left side in the state in which the occupant faces the front is the “left”, and the right side is the “right.”

The expression “bonding” in the present embodiment shall indicate bonding through welding. However, a bonding method other than welding may be used.

The cushion frame structure 3100 has a cushion frame 3300 and a cushion cover 3200 that includes part of the cushion frame 3300 as illustrated in FIG. 17 to FIG. 23.

The cushion frame 3300 has left and right cushion side frames 3310, 3320 arranged at an interval from each other, a back pipe frame 3330 that couples back sides of the left and right cushion side frames 3310, 3320, a lower pipe frame 3340 that couples lower sides of the left and right cushion side frames 3310, 3320, a front pipe frame 3350 extended forward, a pair of left and right front-side legs 3360, 3370, a pair of left and right back-side legs 3380, 3390, a frame bracket 3400 for coupling a seat back frame not illustrated, mounting brackets 3410, 3420 for anchor bolts, and to-be-attached wires 3440, 3450 for a plurality of child safety seats.

The cushion side frames 3310, 3320, the front-side legs 3360, 3370, the back-side legs 3380, 3390, the frame bracket 3400, and the mounting brackets 3410, 3420 described above are formed by press-working flat plates of steel, aluminum alloy, or the like.

The back pipe frame 3330, the lower pipe frame 3340, and the front pipe frame 3350 are formed by bending circular pipes of steel, aluminum alloy, or the like.

The left and right cushion side frames 3310, 3320 each have a sidewall. These sidewalls are spaced in the left-right direction and opposed to each other.

The back pipe frame 3330 and the lower pipe frame 3340 each have a left end bonded to the sidewall and a right end bonded to the sidewall.

The cushion side frames 3310, 3320 respectively have top plates 3312, 3322 and bottom plates 3313, 3323 at upper ends and lower ends of the sidewalls.

Two mounting holes for mounting the seat back frame not illustrated are formed at the front and back in each of the top plates 3312, 3322. Two mounting holes for mounting the cushion frame structure 3100 to the vehicle body are formed at the front and back in each of the bottom plates 3313, 3323. The number of each of the mounting holes can be changed according to necessity.

The back pipe frame 3330 extends in the left-right direction. A substantially U-shaped to-be-attached wire 3440 extended obliquely upward to the front is bonded to each of left and right opposite ends of the back pipe frame 3330.

The to-be-attached wires 3440 are to-be-attached members (also called lower anchorages) to which an ISOFIX-type child safety seat (not illustrated) corresponding to ISOFIX which is the international standard for a system of attaching a child safety seat is to be attached.

The back pipe frame 3330 has curves 3331 gently curved like a crank on the inner side relative to the left end and the right end. The back pipe frame 3330 also has a central portion 3332 between these left and right curves 3331, the central portion 3332 being positioned obliquely upward behind the left end and the right end.

A support pipe frame 3430 is provided on this central portion 3332.

The support pipe frame 3430 is entirely in parallel to the central portion 3332 of the back pipe frame 3330 and positioned obliquely downward ahead of the central portion 3332. The support pipe frame 3430 has opposite ends extended toward and bonded to the central portion 3332.

The frame bracket 3400 has its upper end bonded to the central portion 3332 and its lower end bonded to the support pipe frame 3430, and is bridged between the central portion 3332 and the support pipe frame 3430.

Coupling holes for coupling the seat back frame not illustrated are formed in the upper end and a front surface portion of this frame bracket 3400.

The back-side legs 3380, 3390 are bonded to the support pipe frame 3430 to be aligned to the left and right in a hanging state. The back-side legs 3380, 3390 each have a substantially horizontal bottom plate at a lower end, and a mounting hole for mounting the cushion frame structure 3100 to the vehicle body is formed in the bottom plate.

The lower pipe frame 3340 extends in the left-right direction. The lower pipe frame 3340 has curves 3341 gently curved like a crank on the inner side relative to the left end and the right end. The lower pipe frame 3340 also has a central portion 3342 between these left and right curves 3341, the central portion 3342 being positioned above the left end and the right end.

The mounting brackets 3410, 3420 are supported in a hanging manner on the central portion 3342 to be aligned to the left and right.

The mounting brackets 3410, 3420 are each shaped to uniformly have a substantially U-shaped open cross-section when viewed from the front, and each have an upper end bonded to the central portion 3342 in a state in which an opening of the open cross-section is oriented upward. Two insertion holes through which anchor bolts are to be inserted are formed to the left and right in the bottom of each of the mounting brackets 3410, 3420. The number of each of the insertion holes can be changed according to necessity.

A pair of substantially U-shaped, left and right to-be-attached wires 3450 extended obliquely upward to the front are bonded to the central portion 3342 on the upper side of each of the mounting bracket 3410 and the mounting bracket 3420.

These four to-be-attached wires 3450 are identical to the aforementioned to-be-attached wires 3440.

The front pipe frame 3350 is composed of a front frame portion 3351 extending in the left-right direction, and left and right lateral frame portions 3352, 3353 integrally coupled to the respective left and right ends of the front frame portion 3351.

The lateral frame portions 3352, 3353 have back ends respectively bonded to the left end and the right end of the lower pipe frame 3340. The left and right lateral frame portions 3352, 3353 are extended forward from the lower pipe frame 3340, bent to be extended upward, and coupled to the front frame portion 3351 at their upper ends.

The left and right front-side legs 3360, 3370 are bonded to and deployed on respective upward-extended regions of the left and right lateral frame portions 3352 of the front pipe frame 3350.

The front-side legs 3360, 3370 have bonded ends respectively bonded to the left and right lateral frame portions 3352, extended portions extended forward from lower ends of the respective bonded ends, and bottom plates bent downward at front ends of the extended portions. A mounting hole for mounting the cushion frame structure 3100 to the vehicle body is formed in each of the bottom plates.

The cushion cover 3200 is made of expanded polyurethane (EPU) and is formed across substantially the entire range equivalent to the seat surface in the cushion frame structure 3100 in plan view.

This cushion cover 3200 is formed by foaming expanded polyurethane in a state including the lower pipe frame 3340 and the front pipe frame 3350 of the cushion frame 3300.

The cushion side frames 3310, 3320 are respectively positioned on the outside of left and right lateral portions of the cushion cover 3200.

The back pipe frame 3330 is positioned outside and behind the cushion cover 3200. The support pipe frame 3430 and the frame bracket 3400 supported by the back pipe frame 3330, the back-side legs 3380, 3390 supported by the support pipe frame 3430, and the left and right to-be-attached wires 3440 are also positioned outside and behind the back pipe frame 3330.

The front pipe frame 3350 is included in the cushion cover 3200, while the front-side legs 3360, 3370 provided at the front ends of the front pipe frame 3350 are extended to the outside from the front end of the cushion cover 3200.

The lower pipe frame 3340 is included in the cushion cover 3200, while the to-be-attached wires 3450 supported by the central portion 3342 are extended upward from the back end of the cushion cover 3200 to the outside.

As described above, the cushion frame structure 3100 includes the cushion cover 3200 formed in the range equivalent to the seat surface in plan view and made of expanded polyurethane in order to support the seat cushion from below.

This accomplishes significant weight reduction of the cushion frame structure 3100 as compared with a conventional cushion frame in which a metallic pan frame and a metallic spring material, such as an S-shaped spring, spread flatly are used in order to support the seat cushion from below.

In the cushion frame structure 3100, the members having various functions in the cushion frame 3300 are arranged on the outside of the cushion cover 3200. The various functions in the cushion frame 3300 are thus not impaired.

Restriction of the range in which expanded polyurethane is foamed with a molding tool such that the members having various functions are not included in the cushion cover 3200 facilitates manufacturing of the cushion frame structure 3100.

### <3> Embodiment [2] Related to Panel Frame Structure

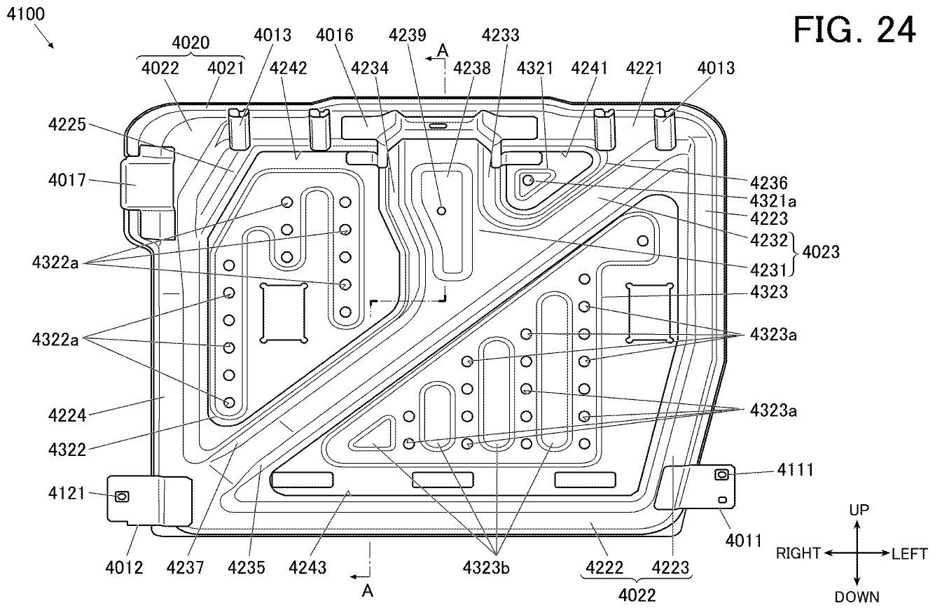

An embodiment [2] related to a panel frame structure will be described based on FIG. 24 to FIG. 42.

The present embodiment relates to a panel frame structure and has industrial availability for them.

### Background Art of Present Embodiment

JP 9-254689A discloses a panel frame structure to be used for a backrest of a rear seat of a vehicle seat.

This panel frame structure accomplishes improvement in strength by combining panel-like frames compositely.

### Problems of Present Embodiment

The conventional panel frame structure has rooms for improvement in strength of the panel frame structure.

An object of the present embodiment, which has been conceived in light of the circumstances described above, is to accomplish improvement in strength of the panel frame structure.

### Solution to Problem

In order to solve the above problem, an invention of the first solution is a panel frame structure comprising:
a first panel frame and a second panel frame bonded in an overlapped state; and
a belt guide,
wherein the belt guide is bridged between the first panel frame and the second panel frame and bonded to the first panel frame and the second panel frame.

An invention according to the second solution is the panel frame structure according to the first solution,
wherein a bead-like reinforcement is formed on the first panel frame, and
wherein the belt guide has regions sandwiching the bead-like reinforcement.

An invention according to the third solution is the panel frame structure according to the second solution,
wherein a plurality of bead-like reinforcements are formed on the first panel frame.

An invention according to the fourth solution is the panel frame structure according to the second solution,
wherein two portions of the belt guide bonded to the second panel frame are arranged to sandwich the bead-like reinforcement.

An invention according to the fifth solution is the panel frame structure according to the fourth solution,
wherein a portion of the belt guide bonded to the second panel frame is arranged to be aligned with a first reinforcement implemented by a protruding/recessed structure formed on the second panel frame.

An invention according to the sixth solution is the panel frame structure according to the fifth solution,
wherein the portions of the belt guide bonded to the second panel frame are arranged to be aligned adjacent to the first reinforcement.

An invention according to the seventh solution is the panel frame structure according to the fifth solution,
wherein another portion of the belt guide bonded to the second panel frame is arranged to be aligned with a second reinforcement implemented by a protruding/recessed structure formed on the second panel frame.

An invention according to the eighth solution is the panel frame structure according to the seventh solution,
wherein the other portion of the belt guide bonded to the second panel frame is arranged to be aligned adjacent to the second reinforcement.

An invention according to the ninth solution is the panel frame structure according to the seventh solution,
wherein the first reinforcement and the second reinforcement are arranged to be aligned on the same plane.

An invention according to the tenth solution is the panel frame structure according to the seventh solution,
wherein the bead-like reinforcements of the first panel frame are shaped to be aligned with the first reinforcement in at least two different directions.

An invention according to the eleventh solution is a panel frame structure comprising:
a first panel frame and a second panel frame bonded in an overlapped state; and
a mounting bracket for a lock device,
wherein the mounting bracket is provided on the first panel frame, and
wherein the first panel frame has a reinforcement implemented by a protruding/recessed structure adjacent to a mounted position of the mounting bracket.

An invention according to the twelfth solution is the panel frame structure according to the eleventh solution,
wherein a support that supports a headrest is provided on the first panel frame, and
wherein the reinforcement implemented by the protruding/recessed structure of the first panel frame is arranged adjacent to the support.

An invention according to the thirteenth solution is a panel frame structure comprising:
a first panel frame and a second panel frame bonded in an overlapped state,
wherein the first panel frame has a frame-like portion bulging to a front side along an outer edge portion, and
wherein the frame-like portion has a region bulging forward by a smaller amount than another region.

### Effects of Solution

In the panel frame structure according to the first solution, the belt guide is bridged between the first panel frame and the second panel frame and bonded to each of them. A load is thus distributed to the first panel frame and the second panel frame if an external force is applied to the belt guide, and the mounting strength of the belt guide is maintained high. Deflection of the panel frame structure under the external force applied to the belt guide is also prevented.

Since the belt guide is bridged between the first panel frame and the second panel frame, the rigidity of the panel frame structure is increased. The functional component required for the panel frame structure thus increases the rigidity of the panel frame structure. The rigidity of the panel frame structure is thus increased while avoiding size increase of the panel frame structure.

In the panel frame structure according to the second solution, the first panel frame has the bead-like reinforcements. The rigidity of the first panel frame is thus increased. Since the belt guide has the regions sandwiching the bead-like reinforcements, the belt guide is supported by the bead-like reinforcement, and the mounting strength of the belt guide is maintained high. Deflection of the panel frame structure under an external force applied to the belt guide is also prevented.

In the panel frame structure according to the third solution, the plurality of bead-like reinforcements are formed on the first panel frame. The rigidity of the first panel frame is thus increased further. Furthermore, the belt guide is supported more firmly.

The panel frame structure according to the fourth solution is arranged such that the two portions of the belt guide bonded to the second panel frame sandwich the bead-like reinforcement. A place between the bonded positions of the two portions bonded to the second panel frame is thus reinforced by the bead-like reinforcement, and the mounting strength of the belt guide is maintained high. Deflection of the panel frame structure under an external force applied to the belt guide is also prevented.

The panel frame structure according to the fifth solution is arranged such that the portions of the belt guide bonded to the second panel frame are aligned with the first reinforcement implemented by the protruding/recessed structure formed on the second panel frame. The belt guide is thus bonded to the periphery of the range reinforced by the first reinforcement and held with high strength.

Since the second panel frame has the first reinforcement, the rigidity of the second panel frame is increased.

The panel frame structure according to the sixth solution is arranged such that the portions of the belt guide bonded to the second panel frame are aligned adjacent to the first reinforcement. The belt guide is thus bonded to the range further reinforced by the first reinforcement and held with higher strength.

The panel frame structure according to the seventh solution is arranged such that the other portion of the belt guide bonded to the second panel frame is aligned with the second reinforcement implemented by the protruding/recessed structure formed on the second panel frame. The belt guide is thus bonded to the periphery of the range reinforced by the second reinforcement and held with high strength.

The panel frame structure according to the eighth solution is arranged such that the other portion of the belt guide bonded to the second panel frame is aligned adjacent to the second reinforcement. The belt guide is thus bonded to the range further reinforced by the second reinforcement and held with higher strength.

The panel frame structure according to the ninth solution is arranged such that the first reinforcement and the second reinforcement are aligned on the same plane. The rigidity of the second panel frame is thus increased. The belt guide bonded to the second panel frame is held with high strength accordingly.

In the panel frame structure according to the tenth solution, the bead-like reinforcements of the first panel frame are shaped to be aligned with the first reinforcement in the at least two different directions. The rigidity of the panel frame structure is thus increased.

In the panel frame structure according to the eleventh solution, the first panel frame has the reinforcement implemented by the protruding/recessed structure adjacent to the mounted position of the mounting bracket for the lock device. The rigidity of the panel frame structure is thus increased. Furthermore, the rigidity of the periphery of the mounted position of the mounting bracket is increased, and the bonding strength of the mounting bracket is increased.

The functional component required for the panel frame structure increases the rigidity of the panel frame structure. The rigidity of the panel frame structure is thus increased while avoiding size increase of the panel frame structure.

In the panel frame structure according to the twelfth solution, the reinforcement implemented by the protruding/recessed structure of the first panel frame is arranged adjacent to the headrest support. The bonding strength of the support is thus improved.

In the panel frame structure according to the thirteenth solution, the first panel frame has the frame-like portion bulging to the front side along the outer edge portion. The rigidity of the first panel frame is thus increased. The frame-like portion has the region bulging forward by a smaller amount than the other region, which accomplishes size reduction in the front-back direction.

### Substance of Embodiment [2] Related to Panel Frame Structure

Hereinafter, an embodiment for carrying out the present invention will be described using the drawings. Technically preferable various limitations will be imposed on the following embodiment in order to carry out the present invention, but are not intended to limit the scope of the present invention to the following embodiment and illustrated examples.

The present embodiment is a panel frame structure to be applied to a backrest of a conveyance bench seat.

Although a conveyance provided with a bench seat to which the panel frame structure which will be described below is applied includes every conveyance that accommodates a human being and moves, such as a vessel, a flight vehicle, or a vehicle, the present embodiment will exemplify a case in which the panel frame structure is applied to a bench seat of a vehicle, in particular, an automobile.

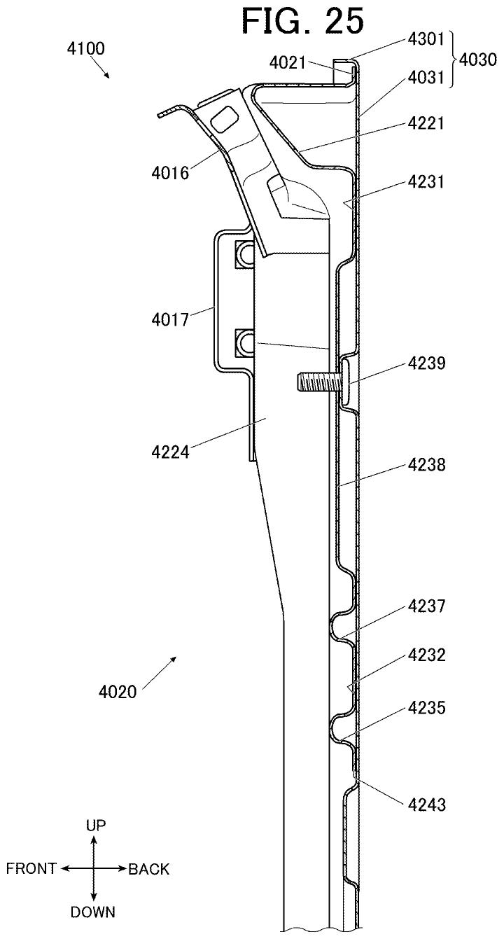

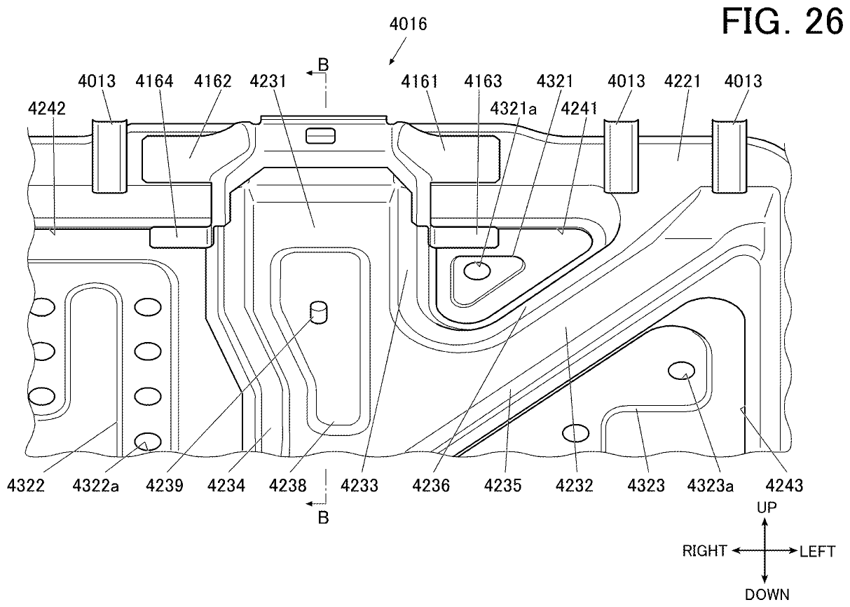

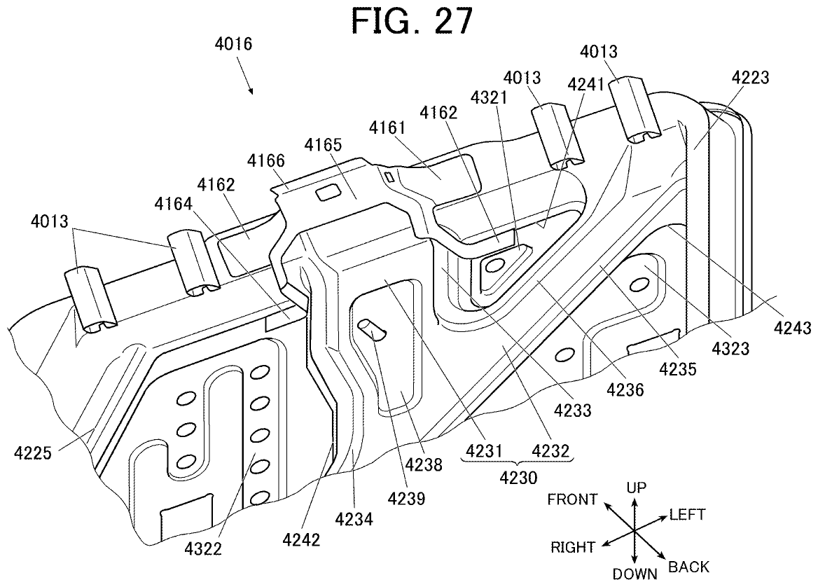

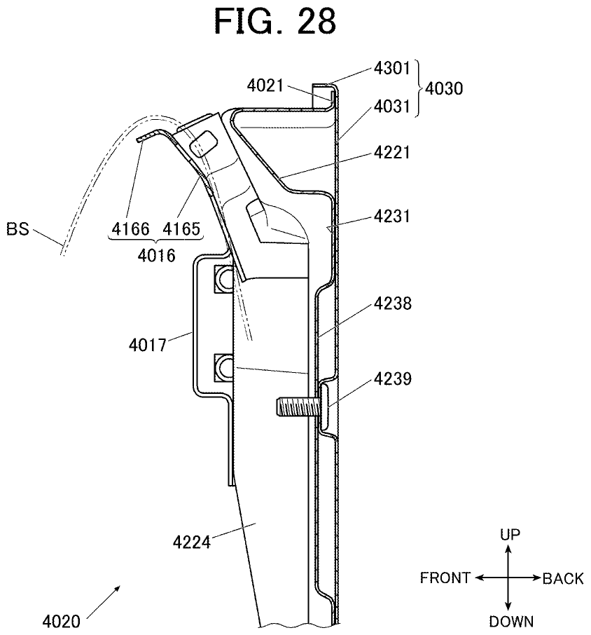

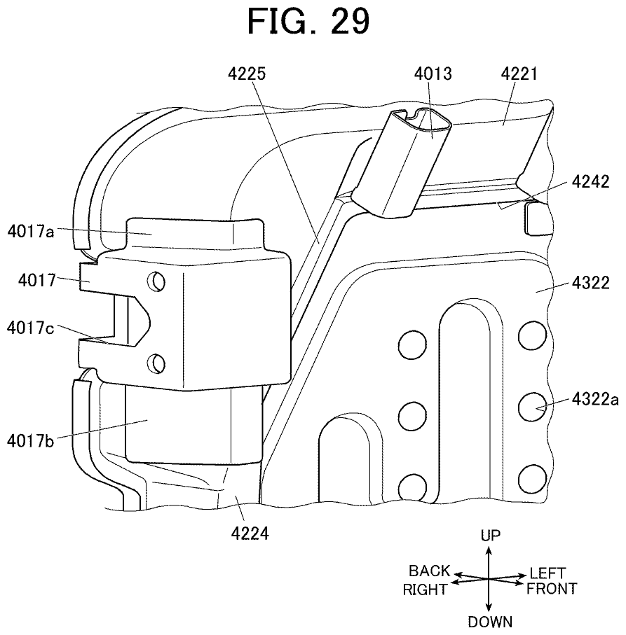

FIG. 24 is a front view of a panel frame structure 4100. FIG. 25 is a cross-sectional view taken along the line A-A in FIG. 24. FIG. 26 is a partial magnified view of a front surface. FIG. 27 is a partial perspective view of the panel frame structure 4100. FIG. 28 is a cross-sectional view taken along the line B-B in FIG. 26. FIG. 29 is a partial magnified view of a right upper portion.

In each of the drawings, up, down, left, right, front, and back directions respectively indicate directions in a state in which the panel frame structure 4100 is mounted on a vehicle. Hereinafter, each part of each panel frame structure 4100 will be described based on the directions in the above-described mounted state.

More precisely, each panel frame structure 4100 is mounted on the vehicle in a state in which its upper end is somewhat inclined backward, but unless otherwise specified, a plate surface of each panel frame structure 4100 shall be in a state lying along the up-down direction and the left-right direction for the sake of description.

The panel frame structure 4100 is intended for a vehicle and utilized as a framework of a backrest of a bench seat. The panel frame structure 4100 is utilized for a backrest of a two-person bench seat.

A foam-molded pad is mounted on the panel frame structure 4100 so as to enclose the panel frame structure 4100 from the front side, and a surface skin is further pulled over the surface of this pad. Pulling over indicates that the surface skin covering the surface of the pad lies over the surface of the pad under tension.

### [General Configuration of Panel Frame Structure]

As illustrated in FIG. 24 to FIG. 29, the panel frame structure 4100 includes a front panel frame 4020 as a first panel frame, a back panel frame 4030 as a second panel frame, set brackets 4011, 4012 for mounting the panel frame structure 4100 to the outside, a plurality of headrest supports 4013, a belt guide 4016, a lock member 4017, and the like.

Each of the front panel frame 4020 and the back panel frame 4030 is a metal plate of steel, aluminum alloy, or the like having a substantially rectangular plate surface shape in front view.

Each of the front panel frame 4020 and the back panel frame 4030 has long sides in front view extending in the left-right direction and short sides extending in the up-down direction. As to the front panel frame 4020 and the back panel frame 4030, the front side of the sheet of drawing of FIG. 24 is the “front”, and the opposite side thereof is the “back.”

The front panel frame 4020 is bonded to the front surface side of the back panel frame 4030.

Respective components of the panel frame structure 4100 are bonded through welding, more preferably through laser welding unless otherwise mentioned. However, a welding method other than laser welding may be used, or a bonding method other than welding may be used.

### [Overview of Front Panel Frame]

A low-height, circumferential wall-like flange 4301 raised forward over substantially the entire circumference of an outer edge portion of the back panel frame 4030 is formed. The front panel frame 4020 is bonded to the front surface portion of the back panel frame 4030 in a state fitted within the inner side of the flange 4301 of the back panel frame 4030. Consequently, the front panel frame 4020 has an outer edge portion smaller than the outer edge portion of the back panel frame 4030 by the thickness of the flange 4301.

### [Front Panel Frame: Outer Edge Portion]

The front panel frame 4020 has an outer edge portion 4021 to be brought into surface contact with the front surface of the back panel frame 4030 over the entire circumference of its outer edge. This outer edge portion 4021 may have a back surface bonded to the front surface of the back panel frame 4030 entirely or partially (in the form of spots).

### [Front Panel Frame: Frame-Like Portion]

The front panel frame 4020 has a frame-like portion 4022 immediately on the inner side of the outer edge portion 4021, the frame-like portion 4022 bulging to the front side over the entire circumference along the outer edge portion 4021. The frame-like portion 4022 is spaced from the front surface of the back panel frame 4030, so that a clearance space is formed.

The frame-like portion 4022 bulges forward along four sides of a substantially rectangular shape, and has an upper frame reinforcement 4221 (frame portion) equivalent to the upper side, a lower frame reinforcement 4222 (frame portion) equivalent to the lower side, a left frame reinforcement 4223 (frame portion) equivalent to the left side, and a right frame reinforcement 4224 (frame portion) equivalent to the right side.

Among them, the upper frame reinforcement 4221 and the lower frame reinforcement 4222 extend in the left-right direction, and the left frame reinforcement 4223 and the right frame reinforcement 4224 extend in the up-down direction.

The expression “ . . . reinforcements” in the following description shall indicate portions or members having rigidity higher than the rigidity of a flat plate because of a three-dimensional structure obtained by deforming a plate surface, such as ridges, frame shapes, protrusions, and bends unless otherwise stated.

A central extended portion 4231 which will be described later is coupled to a central portion in the left-right direction of the upper frame reinforcement 4221. Part of the belt guide 4016 is bonded to the portion of this upper frame reinforcement 4221 to which the central extended portion 4231 is coupled.

The set bracket 4011 is bonded to the vicinity of a lower end of the left frame reinforcement 4223.

The lock member 4017 is bonded to the vicinity of an upper end of the right frame reinforcement 4224, and the set bracket 4012 is bonded to the vicinity of a lower end.

A corner reinforcement 4225 implemented by a bead extending in a direction obliquely upward to the left is formed at a right upper corner of the front panel frame 4020 at which the upper frame reinforcement 4221 and the right frame reinforcement 4224 are coupled in the vicinity of the position on the front panel frame 4020 at which the lock member 4017 is mounted.

### [Front Panel Frame: Coupled Portion]

The front panel frame 4020 has a coupled portion 4023 formed in a three-prong (substantially Y) shape in front view on the inner side of the frame-like portion 4022.

The coupled portion 4023 has a diagonal extended portion 4232 leading from a right end of the lower frame reinforcement 4222 (a right lower corner of the frame-like portion 4022) to a left end of the upper frame reinforcement 4221 (a left upper corner of the frame-like portion 4022) and the central extended portion 4231 branching from a middle portion in the long-side direction of the diagonal extended portion 4232 to lead to a middle portion in the left-right direction of the upper frame reinforcement 4221.

The frame-like portion 4022 and the coupled portion 4023 are coupled integrally.

For the respective extended portions 4231, 4232, bead-like reinforcements 4233 to 4237 in the extended directions are formed at opposite ends in width directions of the respective extended portions 4231, 4232 (directions perpendicular to the extended directions).

For the central extended portion 4231, the bead-like reinforcements 4233, 4234 extending in the extended direction of the central extended portion 4231 are formed respectively at a left edge and a right edge.

The bead-like reinforcement 4235 extending in the extended direction of the diagonal extended portion 4232 over its entire length is formed at a left edge of the diagonal extended portion 4232.

The bead-like reinforcement 4236 formed from a left upper end to the middle portion of the diagonal extended portion 4232 and the bead-like reinforcement 4237 formed from a right lower end to the middle portion of the diagonal extended portion 4232 are formed at a right edge of the diagonal extended portion 4232.

The bead-like reinforcement 4236 is coupled integrally to the bead-like reinforcement 4233 of the central extended portion 4231, and the bead-like reinforcement 4237 is coupled integrally to the bead-like reinforcement 4234 of the central extended portion 4231.

The bead-like reinforcement 4236 and the bead-like reinforcement 4237 are located on the same line, but are divided by the central extended portion 4231.

Each of the bead-like reinforcements 4233 to 4237 is formed to protrude to the front side on the front surface of the front panel frame 4020 and to be recessed to the front side in the back surface.

The number of the bead-like reinforcements 4233 to 4237 can be increased/decreased and may be formed, for example, not only for the respective extended portions 4231, 4232, but also for portions at inner edges of openings 4241 to 4243 which will be described later where the bead-like reinforcements 4233 to 4237 are not formed.

The bead-like reinforcement 4236 and the bead-like reinforcement 4237 may be implemented by a single continuous bead-like reinforcement. In that case, the two bead-like reinforcements 4233, 4234 of the central extended portion 4231 may be configured to cross the single continuous bead-like reinforcement 4236, 4237 to be integrated.

An island-like mounting reinforcement 4238 protruding to the front side on the front surface of the front panel frame 4020 and recessed to the front side in the back surface is formed at a central portion in the width direction of the central extended portion 4231. This mounting reinforcement 4238 serves as a foundation for mounting the retractor (illustration of which is omitted) of the seat belt, and a belt mounted portion 4239 is provided at a central portion of the mounting reinforcement 4238. The belt mounted portion 4239 includes a rivet- or bolt-like member with a shaft portion extending through the mounting reinforcement 4238 to protrude forward and a head being bonded and fixed to a back surface of the mounting reinforcement 4238. The retractor of the seat belt is fixed to the shaft portion of the belt mounted portion 4239 or a front surface of the mounting reinforcement 4238.

### [Front Panel Frame: Openings]

Portions in an inner region enclosed by the frame-like portion 4022 other than the above-described coupled portion 4023 are the three openings 4241, 4242, and 4243 extending widely through the plate surface of the front panel frame 4020 from the front to the back.

The opening 4241 is implemented by a substantially triangular opening surrounded by the upper frame reinforcement 4221, the diagonal extended portion 4232, and the central extended portion 4231.

The opening 4242 is implemented by a substantially trapezoidal opening surrounded by the upper frame reinforcement 4221, the right frame reinforcement 4224, the diagonal extended portion 4232, and the central extended portion 4231.

The opening 4243 is implemented by a substantially triangular opening surrounded by the lower frame reinforcement 4222, the left frame reinforcement 4223, and the diagonal extended portion 4232.

As mentioned earlier, the back surface side of the frame-like portion 4022 of the front panel frame 4020 is entirely spaced from the front surface of the back panel frame 4030.

As illustrated in FIG. 24, inner edge portions of the above-described respective openings 4241 to 4243 are all indented to the back side to be in contact with the front surface of the back panel frame 4030. The inner edge portions of these respective openings 4241 to 4243 and the front surface of the back panel frame 4030 may be bonded entirely or partially (in the form of spots) through laser welding.

The respective openings 4241 to 4243 accomplish weight reduction of the front panel frame 4020.

### [Overview of Back Panel Frame]

As illustrated in FIG. 24 to FIG. 27, the back panel frame 4030 has a plate-like main body plate 4031 having a substantially rectangular shape in front view, and the aforementioned flange 4301 provided integrally with an outer edge portion of the main body plate 4031.

The main body plate 4031 is a flat plate which is entirely flat in the up-down and left-right directions.

### [Back Panel Frame: Opening Reinforcements]

Opening reinforcements 4321 to 4323 are formed respectively in areas of the main body plate 4031 on the inner side of the respective openings 4241 to 4243 of the front panel frame 4020 in a state in which the front panel frame 4020 is overlapped on the back panel frame 4030. These opening reinforcements 4321 to 4323 all protrude forward from the front surface of the main body plate 4031 and are recessed forward when viewed from the back surface.

In an area of the main body plate 4031 on the inner side of the opening 4241 having a substantially right triangular shape, the opening reinforcement 4321 (a first reinforcement) implemented by a protruding/recessed structure in which the entire area of the substantially right triangular shape bulges is formed.

Three sides of the right triangular shape of this opening reinforcement 4321 are substantially in parallel and proximate to the three sides of an inner edge portion of the opening 4241, respectively.

The opening reinforcement 4321 has a flat surface in conformity to the bulging shape of the right triangle, and a circular or substantially circular through-hole 4321a is formed in the flat surface.

In an area of the main body plate 4031 on the inner side of the opening 4242, the opening reinforcement 4322 (a second reinforcement) implemented by a bulging portion (a protruding/recessed structure) having a shape in which three oval extended portions extending in the up-down direction are integrated at their upper ends is formed.

The opening reinforcement 4322 has a flat surface in conformity to the bulging shape, and a plurality of circular or substantially circular through-holes 4322a are formed in the flat surface. The respective through-holes 4322a are formed to be aligned in the up-down direction along the respective three extended portions.

Since the opening reinforcement 4322 has the three oval extended portions in the up-down direction, particularly high rigidity against a bending load in the direction (the left-right direction) perpendicular to the extended portions, for example, is obtained.

In an area of the main body plate 4031 on the inner side of the opening 4243 having a substantially right triangular shape, the opening reinforcement 4323 in which the entire area of the substantially right triangular shape bulges is formed.

The opening reinforcement 4323 has a right triangular shape as a whole and is shaped such that only its upper end bulges to the left.

The opening reinforcement 4323 has a flat surface in conformity to the bulging shape of the substantially right triangular shape, and three oval recesses 4323b extending in the up-down direction and a right triangular recess 4323b are formed within a range of the bulging area of the substantially right triangular shape. Inner bottoms of all of these recesses 4323b are flat plate surfaces identical to the flat plate surface of the main body plate 4031. The three oval recesses 4323b decrease in length in the up-down direction sequentially from the left in correspondence to the bulging shape of the substantially right triangular shape. The right triangular recess 4323b is shaped and oriented to correspond to the acute corner of the opening reinforcement 4323 of the substantially right triangular shape.

The respective recesses 4323b are provided at certain intervals in the left-right direction, and a plurality of through-holes 4323a are formed to be aligned in the up-down direction in bulging portions extending in the up-down direction between the respective recesses 4323b. The through-hole 4323a is also formed in the region bulging to the left in the aforementioned opening reinforcement 4323.

Since the opening reinforcement 4323 has the three oval recesses extending in the up-down direction, ridge reinforcements extending in the up-down direction are formed in the opening reinforcement 4323. Particularly high rigidity against a bending load in the direction (the left-right direction) perpendicular to the ridge reinforcements is thus obtained.

Since the respective opening reinforcements 4321 to 4323 are provided in correspondence to the ranges in which rigidity is decreased by the respective openings 4241 to 4243 of the front panel frame 4020, the rigidity is compensated for by the back panel frame 4030 side to accomplish weight reduction while maintaining the rigidity of the entire panel frame structure 4100 high.

Since the through-holes 4321a to 4323a are formed in the ranges of the bulging areas of the respective opening reinforcements 4321 to 4323, further weight reduction is accomplished while preventing decrease in rigidity.

### [Set Brackets]

The left set bracket 4011 is bonded through laser welding to the front surface side at a left end lower portion of the front panel frame 4020, that is, at the lower end of the left frame reinforcement 4223 as illustrated in FIG. 24.

The right set bracket 4012 is bonded through laser welding to the front surface side at a right end lower portion of the front surface of the front panel frame 4020, that is, at a corner where the right end of the lower frame reinforcement 4222 and the lower end of the right frame reinforcement 4224 cross each other.

Each of the set brackets 4011, 4012 is a member obtained by press-working a metal plate thicker than the front panel frame 4020 and the back panel frame 4030 to obtain a three-dimensional structure. The set brackets 4011, 4012 each have a flat plate-like extended portion protruding from the bonding surface by one step and extended to the left or right. Projection nuts 4111, 4121 are fixedly deployed on front surfaces of the respective extended portions through projection welding. Fixation bolts are threaded into these projection nuts 4111, 4121 when the panel frame structure 4100 is fixed to a vehicle seat.

### [Belt Guide]

The belt guide 4016 is a member for guiding upward a seat belt pulled out from the retractor (illustration of which is omitted) mounted on the mounting reinforcement 4238 of the front panel frame 4020.

The belt guide 4016 is bonded through laser welding to the front surface side at the upper end of the front panel frame 4020, that is, at the central portion in the left-right direction of the upper frame reinforcement 4221 as illustrated in FIG. 24 to FIG. 28.

The belt guide 4016 is a member obtained by press-working a metal plate thicker than the front panel frame 4020 and the back panel frame 4030 to obtain a predetermined structure.

The belt guide 4016 has a pair of left and right legs 4161, 4162 bonded to the front surface of the upper frame reinforcement 4221, and a pair of left and right legs 4163, 4164 extended downward along both left and right lateral surfaces of the central extended portion 4231 and extended at the lower end separately to the left and right, as illustrated in FIG. 26.

The legs 4163, 4164 have their lower ends bonded to the back surface of the back panel frame 4030 through the openings 4241, 4242.

As illustrated in FIG. 28, the belt guide 4016 has a bridge portion 4165 bridged between the left legs 4161, 4163 and the right legs 4162, 4164. The bridge portion 4165 is spaced from the front surface of the upper frame reinforcement 4221, so that a clearance is formed. This clearance functions as an insertion portion through which the seat belt is to be inserted upward from below.

A guide 4166 curved obliquely downward to the front is provided at an upper end of the bridge portion 4165. The seat belt BS inserted upward from below on the inner side of the bridge portion 4165 is folded back at the guide 4166 to be guided obliquely downward to the front.

### [Lock Member]

The lock member 4017 is a mounting bracket for mounting a lock device not illustrated. The lock device is a mechanism for locking the panel frame structure 4100 into a predetermined posture (for example, a rugged state illustrated in FIG. 24) in a state in which the lower end of the panel frame structure 4100 is supported on the vehicle seat so as to be rotatable around a rotation axis extending in the left-right direction.

The lock member 4017 is bonded through laser welding to the front surface side in the vicinity of the right upper corner of the front panel frame 4020, that is, the upper end of the right frame reinforcement 4224 as illustrated in FIG. 24 and FIG. 29.

The lock member 4017 is a member obtained by press-working a metal plate thicker than the front panel frame 4020 and the back panel frame 4030 to obtain a predetermined structure.

The lock member 4017 has a pair of upper and lower legs 4017a, 4017b bonded to the front surface and an outer inclined surface inclined obliquely forward to the left side of the right frame reinforcement 4224. The upper and lower legs 4017a, 4017b are each formed into a bent flat-plate shape so as to come into close contact with the front surface and the inclined surface of the upper frame reinforcement 4221.

The lock member 4017 also has a right lateral portion, and a notch 4017c for avoiding interference when a lock pin that restricts rotation of the panel frame structure 4100 is inserted into the lock device from the right is formed in the right lateral portion.

Consequently, the panel frame structure 4100 is locked suitably when the lock pin is inserted into the lock device mounted on the lock member 4017.

The corner reinforcement 4225 implemented by a bead extending in a direction obliquely upward to the left is formed on the front panel frame 4020 on the left of and adjacent to a mounted position of the lock member 4017. The rigidity at the periphery of the mounted position of the lock member 4017 on the front panel frame 4020 side is thus increased, and improvement in mounting strength of the lock member 4017 is accomplished.

### [Headrest Supports]

The headrest supports 4013 are bonded in pairs through laser welding to the front surface side at the upper end of the front panel frame 4020, that is, at the left side and the right side of the upper frame reinforcement 4221 as illustrated in FIG. 24 and FIG. 27.

Each of the supports 4013 is a substantially rectangular, cylindrical member obtained by bending a metal plate and mounted on the front panel frame 4020 in the orientation in the up-down direction. The supports 4013 support the headrest in a state in which struts of the headrest are inserted into the inner side of the supports 4013 from above.

The aforementioned corner reinforcement 4225 is formed on the front panel frame 4020. The corner reinforcement 4225 is positioned above and adjacent to and on the right of and adjacent to the mounted positions of the right two supports 4013. The rigidity at the peripheries of the mounted positions of the right two supports 4013 on the front panel frame 4020 side is thus increased, and improvement in mounting strength of these supports 4013 is accomplished.

### Technical Effects of Embodiment of Invention

In the panel frame structure 4100 having the above-described configuration, the belt guide 4016 is arranged to be is bridged between the front panel frame 4020 and the back panel frame 4030. A load is thus distributed to the front panel frame 4020 and the back panel frame 4030 if an external force is applied to the belt guide 4016, and the mounting strength of the belt guide 4016 is maintained high. Deflection of the panel frame structure 4100 under the external force applied to the belt guide 4016 is also prevented.

Furthermore, since the belt guide 4016 is bridged between the front panel frame 4020 and the back panel frame 4030, the front panel frame 4020 and the back panel frame 4030 are restrained by each other to increase the rigidity of the panel frame structure 4100. Since the functional component required for the panel frame structure 4100 increases the rigidity of the panel frame structure 4100, the rigidity of the panel frame structure 4100 is increased while avoiding size increase of the panel frame structure 4100.

In the panel frame structure 4100, the legs 4161, 4162 of the belt guide 4016 are bonded to the front panel frame 4020, and the legs 4163, 4164 are bonded to the back panel frame 4030.

The pair of lower legs 4163, 4164 of the belt guide 4016 have a region sandwiching the bead-like reinforcements 4233, 4234 formed on both the left and right sides of the central extended portion 4231 of the front panel frame 4020.

The bead-like reinforcements 4233, 4234 increase the rigidity of the front panel frame 4020. Furthermore, since the pair of lower legs 4163, 4164 have the region sandwiching the bead-like reinforcements 4233, 4234, the belt guide 4016 is supported by the bead-like reinforcements 4233, 4234, and the mounting strength of the belt guide 4016 is maintained high. Deflection of the panel frame structure 4100 under an external force applied to the belt guide 4016 is also prevented.

In particular, since the pair of lower legs 4163, 4164 are bonded to the back panel frame 4030, a place between positions of the two legs 4163, 4164 bonded to the back panel frame 4030 is reinforced by the bead-like reinforcements 4233, 4234, and the mounting strength of the belt guide 4016 is maintained high.

The portion of the leg 4163 of the belt guide 4016 bonded to the back panel frame 4030 is positioned above the opening reinforcement 4321 and furthermore, above and adjacent to the opening reinforcement 4321. The leg 4163 is thus bonded to the vicinity of the range reinforced by the opening reinforcement 4321 and held with high strength. The bonded portion of the leg 4163 may be positioned at any place in the up, down, left, right, or an oblique direction of the opening reinforcement 4321.

The portion of the leg 4164 of the belt guide 4016 bonded to the back panel frame 4030 is positioned above the opening reinforcement 4322 and furthermore, above and adjacent to the opening reinforcement 4322. The leg 4164 is thus bonded to the vicinity of the range reinforced by the opening reinforcement 4322 and held with high strength.

The bonded portion of the leg 4164 may be positioned at any place in the up, down, left, right, or an oblique direction of the opening reinforcement 4322.

In the panel frame structure 4100, the bead-like reinforcements 4233, 4236 of the front panel frame 4020 coupled integrally are shaped to enclose the opening reinforcement 4321 in at least two different directions in front view. Interaction between the bead-like reinforcements 4233, 4236 and the opening reinforcement 4321 thus increases the rigidity of the panel frame structure 4100.

The back panel frame 4030 of the panel frame structure 4100 is arranged such that the opening reinforcement 4321 and the opening reinforcement 4322, and furthermore, the opening reinforcement 4323 are aligned on the same plane. The rigidity of the entire back panel frame 4030 is thus increased. The belt guide 4016 and the front panel frame 4020 bonded to the back panel frame 4030 are held with high strength accordingly.

In the panel frame structure 4100, the front panel frame 4020 has the corner reinforcement 4225 implemented by a bead as a protruding/recessed structure adjacent to the mounted position of the lock member 4017. The rigidity of the panel frame structure 4100 is thus increased. Furthermore, the rigidity of the periphery of the mounted position of the lock member 4017 is increased, and the bonding strength of the lock member 4017 is increased.

Since the lock member 4017 as the functional component required for the panel frame structure 4100 increases the rigidity of the panel frame structure 4100, the rigidity of the panel frame structure 4100 is increased while avoiding size increase of the panel frame structure 4100.

In the panel frame structure 4100, the corner reinforcement 4225 of the front panel frame 4020 is arranged adjacent to the right two headrest supports 4013. The bonding strength of the supports 4013 is thus improved.

### [Another Example of Frame-Like Portion of Front Panel Frame]

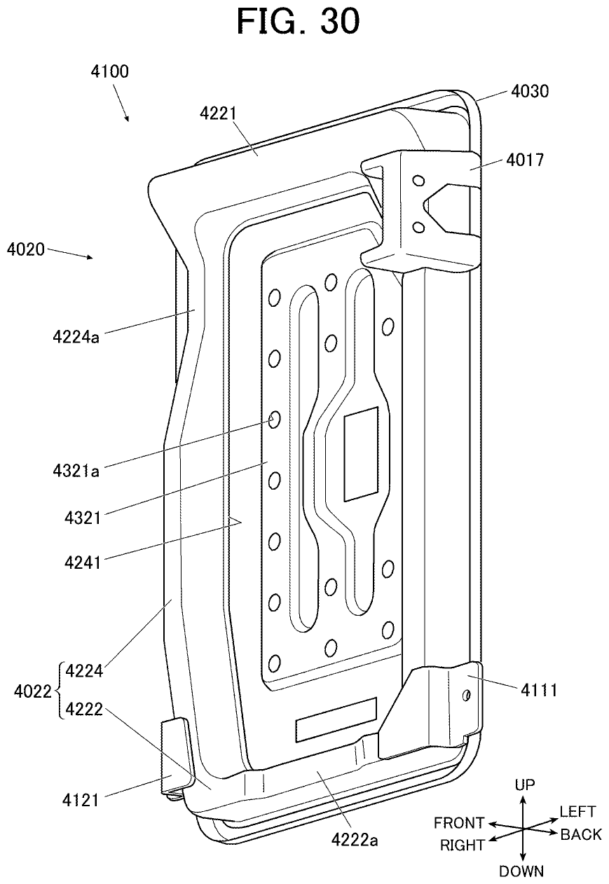

Another example of the frame-like portion of the front panel frame is illustrated in FIG. 30. The panel frame structure 4100 illustrated in FIG. 30 is a panel frame structure to be utilized for a backrest of a one-person seat. Components of the panel frame structure 4100 in FIG. 30 substantially equal in function to those of the panel frame structure 4100 illustrated in FIG. 24 to FIG. 29 are denoted by the same reference numerals, and repeated description thereof will be omitted.

In this panel frame structure 4100, the right frame reinforcement 4224 has a region 4224a bulging forward by a smaller amount than another region of the right frame reinforcement 4224 at the frame-like portion 4022 of the front panel frame 4020.

Similarly, the lower frame reinforcement 4222 has a region 4222a bulging forward by a smaller amount than another region of the lower frame reinforcement 4222.

Since the front panel frame 4020 has the frame-like portion 4022 and has the regions 4222a, 4224a bulging forward by a smaller amount than other regions as described above, the rigidity of the front panel frame 4020 is increased, and partial size reduction in the front-back direction is accomplished.

In the case of the aforementioned panel frame structure 4100 illustrated in FIG. 24 to FIG. 29, the lower half of the right frame reinforcement 4224 bulges forward by a smaller amount than the upper half as illustrated in FIG. 25, and it can be said that the panel frame structure 4100 has a region bulging by a small amount. The same technical effects as those of the panel frame structure 4100 in FIG. 30 are thus obtained.

### Another Example of Coupled Portion of Front Panel Frame

The coupled portion 4023 provided on the inner side of the frame-like portion 4022 of the front panel frame 4020 is not limited to one having a substantially y-shape in front view as illustrated in FIG. 24.

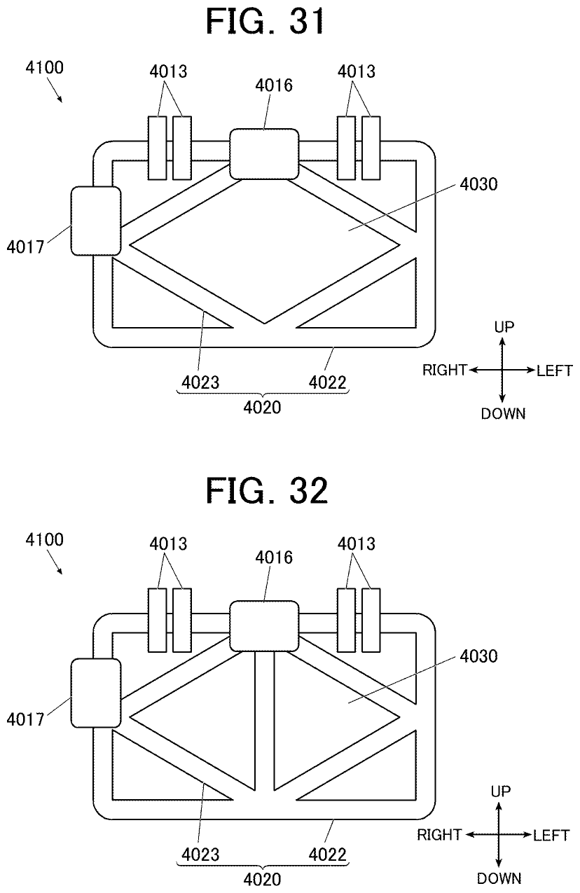

FIG. 31 to FIG. 40 illustrate examples of various other forms of the coupled portion 4023 in schematic diagrams in front view.

FIG. 31 is the coupled portion 4023 in which four extended portions, each of which couples midpoints of adjacent sides of the four sides of the rectangular frame-like portion 4022, are integrated. The coupled portion 4023 and the frame-like portion 4022 are also integrated. The same applies to the following examples of other forms.

FIG. 32 is the coupled portion 4023 in which an extended portion that couples the midpoint of the upper side and the midpoint of the lower side of the frame-like portion 4022 is further added to and integrated with the configuration of the coupled portion 4023 in FIG. 31.

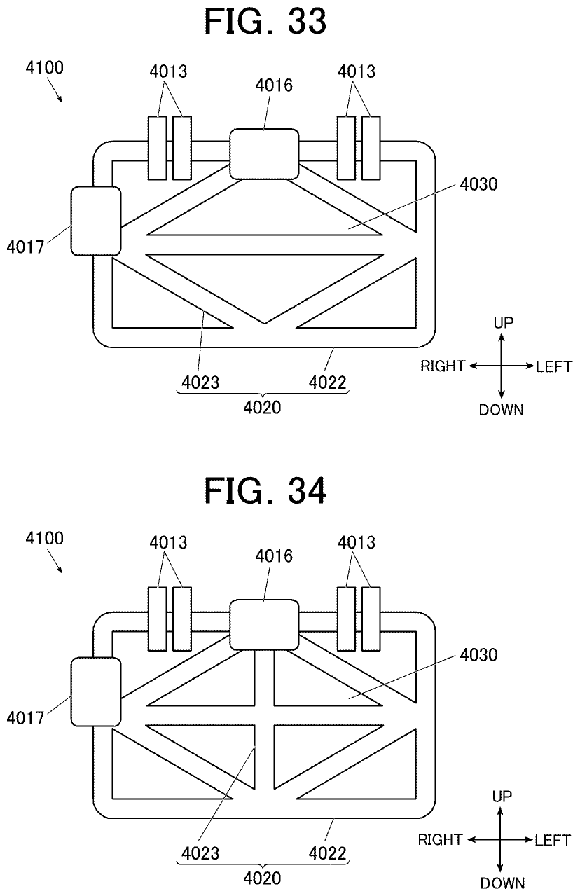

FIG. 33 is the coupled portion 4023 in which an extended portion that couples the midpoint of the left side and the midpoint of the right side of the frame-like portion 4022 is further added to and integrated with the configuration of the coupled portion 4023 in FIG. 31.

FIG. 34 is the coupled portion 4023 in which an extended portion that couples the midpoint of the left side and the midpoint of the right side of the frame-like portion 4022 is further added to and integrated with the configuration of the coupled portion 4023 in FIG. 32.

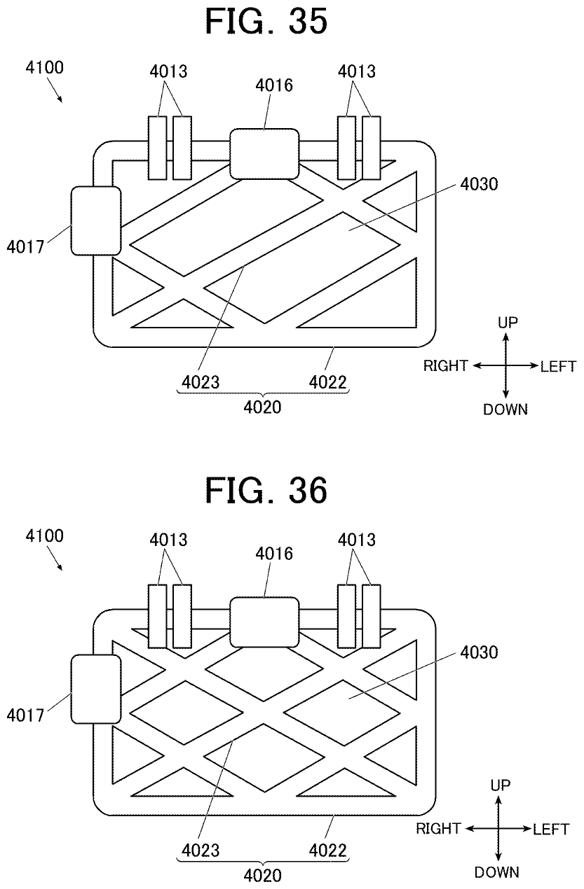

FIG. 35 is the coupled portion 4023 in which an extended portion that couples the left upper corner and the right lower corner of the frame-like portion 4022 is further added to and integrated with the configuration of the coupled portion 4023 in FIG. 31. The coupled portion 4023 in which an extended portion that couples a right upper corner and a left lower corner of the frame-like portion 4022 is added to and integrated with the configuration of the coupled portion 4023 in FIG. 31 may be adopted.

FIG. 36 is the coupled portion 4023 in which an extended portion that couples the right upper corner and the left lower corner of the frame-like portion 4022 is added to and integrated with the configuration of the coupled portion 4023 in FIG. 35.

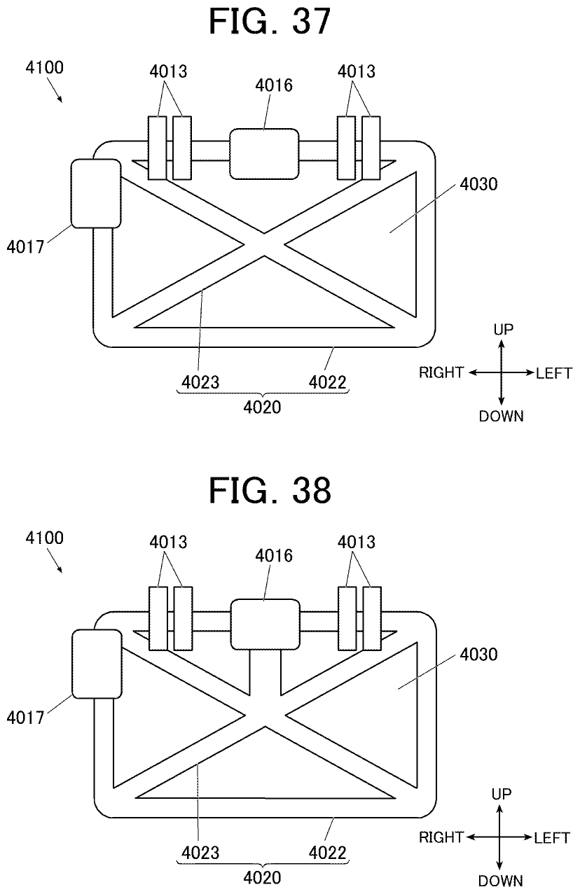

FIG. 37 is the coupled portion 4023 in which an extended portion that couples the left upper corner and the right lower corner of the frame-like portion 4022 and an extended portion that couples the right upper corner and the left lower corner of the frame-like portion 4022 are integrated.

FIG. 38 is the coupled portion 4023 in which an extended portion that couples a crossing position of the two extended portions of the coupled portion 4023 and the midpoint of the upper side of the frame-like portion 4022 is further added to and integrated with the coupled portion 4023 in FIG. 37.

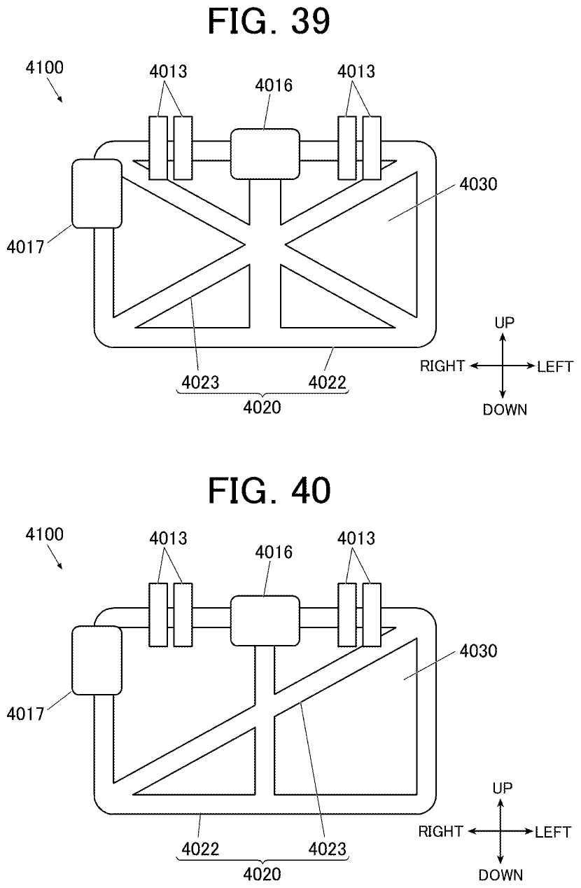

FIG. 39 is the coupled portion 4023 in which an extended portion that couples the midpoint of the upper side of the frame-like portion 4022 and the midpoint of the lower side of the frame-like portion 4022 is further added to and integrated with the coupled portion 4023 in FIG. 37.

FIG. 40 is the coupled portion 4023 in which an extended portion that couples the left upper corner and the right lower corner of the frame-like portion 4022 and an extended portion that couples the midpoint of the upper side of the frame-like portion 4022 and the midpoint of the lower side of the frame-like portion 4022 are integrated. The extended portion that couples the left upper corner and the right lower corner of the frame-like portion 4022 may be replaced by the extended portion that couples the right upper corner and the left lower corner of the frame-like portion 4022. Similarly, the extended portion that couples the midpoint of the upper side of the frame-like portion 4022 and the midpoint of the lower side of the frame-like portion 4022 may be replaced by the extended portion that couples the midpoint of the left side of the frame-like portion 4022 and the midpoint of the right side of the frame-like portion 4022.

The coupled portion 4023 in which the extended portion that couples the midpoint of the left side of the frame-like portion 4022 and the midpoint of the right side of the frame-like portion 4022 is further added to and integrated with the coupled portion 4023 in FIG. 40 may be adopted.

The coupled portions 4023 illustrated in FIG. 31 to FIG. 40 may be changed to make the width of any of the individual extended portions constituting the coupled portions 4023 larger/smaller than the width of other extended portions. In this case, the width of a section of an individual extended portion may further be changed to be larger/smaller than the width of another section. In this case, a section of an extended portion is preferably defined as a range from an end of the extended portion to any separator or a range from any separator to another separator where the separator is defined as a position of intersection with another extended portion.

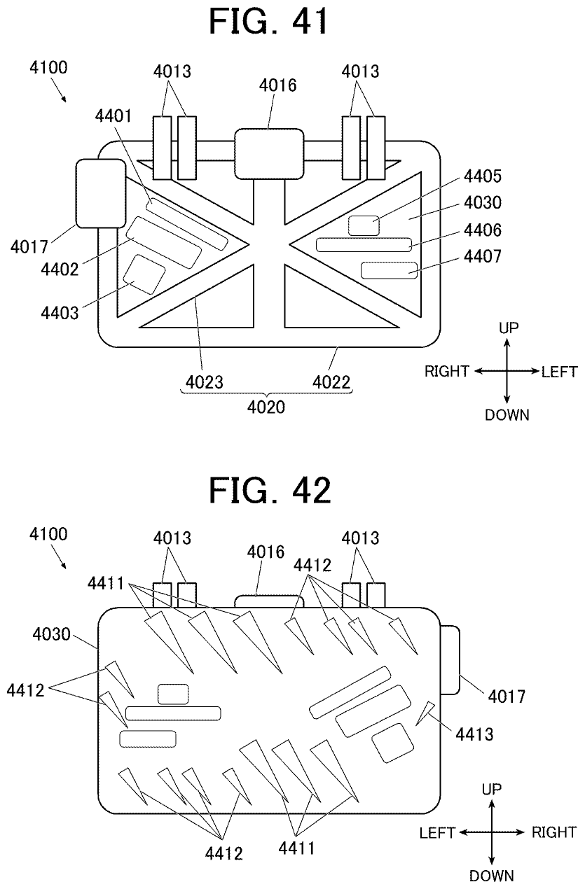

FIG. 41 is a schematic diagram illustrating an example in which reinforcements 4401 to 4403 and 4405 to 4407 implemented by beads are provided instead of the aforementioned opening reinforcements 4321 to 4323 or in combination with the opening reinforcements 4321 to 4323 in areas of the back panel frame 4030 to be the inner side of the openings of the front panel frame 4020.

Although this FIG. 41 uses the panel frame structure 4100 in FIG. 39 as an example, reinforcements implemented by beads may be provided similarly for each of the panel frame structures 4100 in FIG. 24, FIG. 31 to FIG. 38, and FIG. 40.

In the example of FIG. 41, the three reinforcements 4401 to 4403 are formed to be aligned in the up-down direction in the right opening of the front panel frame 4020. The three reinforcements 4405 to 4407 are formed to be aligned in the up-down direction in the left opening of the front panel frame 4020.

The reinforcements 4401 to 4403 and 4405 to 4407 are each implemented by a substantially rectangular bead with rounded corners. The entire area of a front-view shape of each of the reinforcements 4401 to 4403 and 4405 to 4407 bulges forward to protrude to the front side on the front surface of the back panel frame 4030 and to be recessed to the front side in the back surface.

The respective reinforcements 4401 to 4403 and 4405 to 4407 are formed to be substantially in parallel in the long-side direction for each of the openings that surround them.

For example, the respective reinforcements 4401 to 4403 in the right opening of the front panel frame 4020 are all formed to be in parallel in a direction obliquely upward to the right. The respective reinforcements 4401 to 4403 may further be formed to be in parallel to an extended portion of the coupled portion 4023, such as the extended portion that couples the right upper corner and the left lower corner of the frame-like portion 4022.

The respective reinforcements 4405 to 4407 in the left opening of the front panel frame 4020 are all formed to be in parallel in the left-right direction.

The reinforcements 4401 to 4403 in the right opening are all different in width in the long-side direction and width in the short-side direction. The same applies to the reinforcements 4405 to 4407 in the left opening.

In the case of the reinforcements 4401 to 4403 in the right opening, the uppermost reinforcement 4401 is the longest in the long-side direction and the shortest in the short-side direction. The lowermost reinforcement 4403 is the shortest in the long-side direction and the longest in the short-side direction.

In the case of the reinforcements 4405 to 4407 in the left opening, the uppermost reinforcement 4405 is the shortest in the long-side direction and the longest in the short-side direction. The second reinforcement 4406 is the longest in the long-side direction and the shortest in the short-side direction.

All of the reinforcements 4401 to 4403 and 4405 to 4407 are formed below the upper end of the lock member 4017.

However, all of the reinforcements 4401 to 4403 and 4405 to 4407 may be formed to reach above the upper end of the lock member 4017.

The reinforcements 4401 to 4403 and the reinforcements 4405 to 4407 can be changed in orientation in each of the openings. For example, the reinforcements 4401 to 4403 or the reinforcements 4405 to 4407 may be in parallel to an inner edge portion of the opening surrounding the reinforcements 4401 to 4403 or the reinforcements 4405 to 4407.

The lengths of the reinforcements 4401 to 4403 and the reinforcements 4405 to 4407 in the long-side direction and short-side direction are not limited to those in the above-described example, and any of the reinforcements may be the longest. In this case, the reinforcements may be arranged in conformity to the shape of an area on the inner side of an opening in such a distribution that the reinforcements are balanced in the area. For example, if the area on the inner side of an opening is triangular, a plurality of reinforcements in parallel to a base may be arranged such that the lengths in the long-side direction decrease in order from the base to the apex angle. Alternatively, in a case of a plurality of reinforcements in parallel to a perpendicular from the apex angle to a base, the reinforcements may be arranged such that a reinforcement closest to the perpendicular is the longest in the long-side direction and the other reinforcements become shorter in the long-side direction toward the base angles on the opposite sides.

Reinforcements implemented by beads as described above may be formed in an area on the inner side of an opening other than the left and right openings.

The reinforcements may be configured to have different orientations in the long-side direction in each of the openings.

Any number of reinforcements may be provided in the openings.

The substantially rectangular reinforcements 4401 to 4403 and 4405 to 4407 have been exemplified, but may have another shape. For example, each of the reinforcements may have an oval, circular, substantially square, triangular, or wedge shape. Each of the reinforcements may be shaped to be long in any direction. The respective reinforcements 4401 to 4403 and 4405 to 4407 may not have a uniform shape.

Furthermore, the reinforcements 4401 to 4403 and 4405 to 4407 may bulge to protrude uniformly to the back side.

In the case in which the reinforcements 4401 to 4403 and the reinforcements 4405 to 4407 are provided on the back panel frame 4030 as in the example of FIG. 41, the rigidity of the panel frame structure 4100 is also increased.

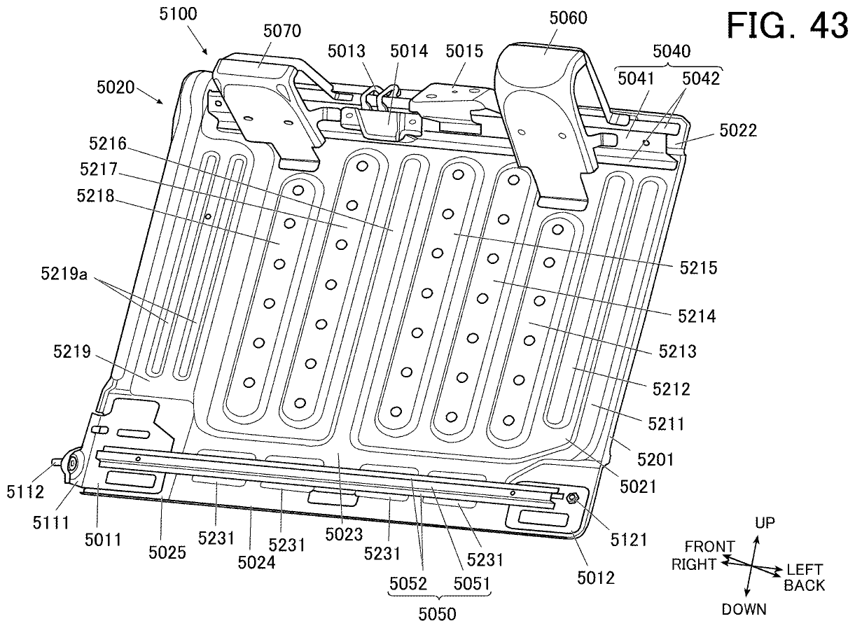

FIG. 42 is a schematic diagram in rear view in which new linear reinforcements 4411 to 4413 have been added to the back panel frame 4030 of the panel frame structure 4100 in FIG. 41.

As illustrated, the other reinforcements 4411 to 4413 may be provided in an area of the back panel frame 4030 other than the areas in which the reinforcements 4401 to 4403 and 4405 to 4407 are formed, for example, an area not overlapped on the respective openings 4241 to 4243 and the coupled portion 4023 of the front panel frame 4020 (an area outside the respective openings 4241 to 4243 and the coupled portion 4023 and an area overlapped on the frame-like portion 4022) in the state in which the front panel frame 4020 is overlapped on the back panel frame 4030. The other reinforcements 4411 to 4413 may be provided at the outer edge portion of the back panel frame 4030. Some or all of the other reinforcements 4411 to 4413 may be formed to cross and connect to the aforementioned other reinforcements. The expression that “the reinforcements connect” or “the reinforcements are continuous” indicates that in a case in which two reinforcements are each protruding in the same direction, for example, the protruding state is maintained and uninterrupted at their boundary. The two reinforcements may have a difference in level because of a difference in protruding amount.

Although this FIG. 42 also uses the panel frame structure 4100 in FIG. 39 as an example, the reinforcements 4411 to 4413 may be provided similarly for each of the panel frame structures 4100 in FIG. 24, FIG. 31 to FIG. 38, and FIG. 40.

The reinforcements 4411 to 4413 are reinforcements implemented by long beads.

The respective reinforcements 4411 to 4413 are each implemented by a long wedge-shaped bead extending in an oblique direction not in parallel to the left-right direction and the up-down direction. The entire area of a front-view shape of each of the reinforcements 4411 to 4413 bulges forward to protrude to the front side on the front surface of the back panel frame 4030 and to be recessed to the front side in the back surface.

Each of the reinforcements 4411 has sizes in the long-side direction and the short-side direction larger than those of each of the reinforcements 4412, and each of the reinforcements 4412 has sizes in the long-side direction and the short-side direction larger than those of each of the reinforcements 4413.

The plurality of reinforcements 4411, 4412, and 4413 may be arranged respectively as groups for each same type of reinforcements in a state gathered for each same type of the reinforcements 4411 to 4413 or in a state aligned in a certain direction for each same type of the reinforcements 4411 to 4413. The various reinforcements 4411 to 4413 may be present in a mixed manner.

The orientation in the long-side direction of all of the reinforcements 4411, 4412, and 4413 may be aligned uniformly, or the direction of each same type of the reinforcements 4411, 4412, and 4413 may be aligned. All of the reinforcements 4411, 4412, and 4413 may be oriented at random. Only some of the reinforcements 4411, 4412, and 4413 may be oriented differently.

Any of the reinforcements 4411, 4412, and 4413 may be arranged to be adjacent to or overlapped on the mounted position of the lock member 4017 in the up-down direction, the left-right direction, or a synthetic direction of the up-down and left-right directions on the back panel frame 4030 in front view. This increases the rigidity at the periphery of the mounted position of the lock member 4017 on the front panel frame 4020 side through the back panel frame 4030, and improvement in mounting strength of the lock member 4017 is accomplished.

The respective reinforcements 4411 to 4413 may have a long shape (such as rectangle or oval) other than the wedge shape. The respective reinforcements 4411 to 4413 may not have a uniform shape.

The reinforcements 4411 to 4413 may be implemented only by a single type of reinforcements rather than being implemented by the plurality of types of the reinforcements 4411 to 4413.

The reinforcements 4411 to 4413 may bulge to protrude uniformly to the back side.

In the case in which the other reinforcements 4411 to 4413 are provided on the back panel frame 4030 as in the example of FIG. 42, the rigidity of the panel frame structure 4100 is also increased further.

The flange 4301 is provided at the outer edge portion of the back panel frame 4030 to accomplish improvement in rigidity and strength in conformity to the extending direction of the flange 4301, while the other reinforcements 4411 to 4413 are provided at an inclination relative to the outer edge portion of the back panel frame 4030. Improvement in rigidity and strength in conformity to directions different from that of the flange 4301 is thus accomplished to withstand stresses on the panel frame structure 4100 in more directions.

In the case in which the other reinforcements 4411 to 4413 are provided at an inclination relative to the outer edge portion of the back panel frame 4030, deflection that would occur at the outer edge of the back panel frame 4030 is prevented, and improvement in strength of the entire panel frame structure 4100 is accomplished. Particularly since the plurality of other reinforcements 4411 to 4413 are provided, the strength of the outer edge of the panel frame structure 4100 is further improved in conformity to the number.

In a case of a configuration in which the respective reinforcements 4411 to 4413 include some reinforcements extending in different directions, deflection in the plurality of different directions is prevented, decrease in strength that would occur disproportionately in a certain direction is prevented, and the strength of the panel frame structure 4100 is further improved.

In a case in which the other reinforcements 4411 to 4413 are arranged to increase the rigidity of the front panel frame 4020 at positions other than the positions corresponding to the openings 4241 to 4243, overall deflection that would be caused by the decrease in strength of the front panel frame 4020 because of the openings 4241 to 4243 is prevented, and weight reduction because of the openings 4241 to 4243 is accomplished without causing overall decrease in strength.

In a case in which the other reinforcements 4411 to 4413 are formed to connect to other reinforcements of the back panel frame 4030, they integrally reinforce a wide range, and improvement in strength of the panel frame structure 4100 is accomplished. Since the reinforcements connect to one another, decrease in strength at boundary portions of the reinforcements is prevented.

In a case in which the other reinforcements 4411 to 4413 are provided to be aligned with the lock member 4017 in any direction along the plate surface of the main body plate 4031, the periphery of the lock member 4017 on the front panel frame 4020 is reinforced by the other reinforcements 4411 to 4413 through the back panel frame 4030, and the mounting strength of the panel frame structure 4100 is improved.

### [Others]

The embodiments of the present invention have been described above. However, the present invention is not limited to the above-described embodiments. For example, a constituent element formed integrally by a single member in the embodiments may be replaced by a constituent element divided into a plurality of members coupled or secured to each other. A constituent element composed of a plurality of coupled members may be replaced by a constituent element formed integrally by a single member. Besides, the details shown in the embodiments can be changed as appropriate without departing from the spirit of the invention.

The structure in which all the various reinforcements formed on the panel frame structure 4100 are obtained by deforming plate materials of the front panel frame 4020 and the back panel frame 4030 to form protrusions or ridges, thereby increasing the strength and rigidity has been exemplified. However, the structure of the reinforcements is not limited to this, and a structure in which bends are formed on the plate material of the front panel frame 4020 or the back panel frame 4030 to increase the strength and rigidity, or the like, for example, may be utilized.

However, although the above-described various reinforcements can also be configured by bonding/attaching new members to the front panel frame 4020 or the back panel frame 4030, a configuration obtained by altering the plate material of the front panel frame 4020 or the back panel frame 4030 to increase the strength and rigidity is more preferable from the viewpoint of weight reduction.

As an embodiment of the invention, the panel frame structure 4100 to be used for a laterally-wide two-person bench seat has been exemplified. However, the technical characteristics of the panel frame structure 4100 described above may be applied to a panel frame structure reduced in lateral width to be used for a one-person seat.

Similarly, the technical characteristics of the panel frame structure 4100 described above may be applied to a panel frame structure increased in lateral width to be used for a seat for more than two persons.

The panel frame structure 4100 having a substantially rectangular shape has been exemplified, but may have a substantially square shape.

### <4> Embodiment [3] Related to Panel Frame Structure

An embodiment [3] related to a panel frame structure will be described based on FIG. 43 to FIG. 45.

The present embodiment relates to a panel frame structure, and has industrial availability for them.

### Background Art of Present Embodiment

JP 2001-519281A discloses a panel frame structure to be used for a backrest of a rear seat of a vehicle seat.

This panel frame structure has a panel-like front frame and a panel-like back frame entirely overlapped and bonded. Embossed portions protruding to the front side are formed on the front frame, and embossed portions protruding to the back side are formed on the back frame.

### Problems of Present Embodiment

However, the mounting strength of a headrest frame mounted on the panel frame structure is not considered in the above-described conventional panel frame structure, leaving room for improvement in this respect.

An object of the present embodiment, which has been conceived in light of the circumstances described above, is to accomplish improvement in mounting strength of a headrest frame.

### Solution to Problem

In order to solve the above problems, an invention according to the first solution is a panel frame structure comprising:
a panel frame;
a reinforcement frame bonded to a front surface side of the panel frame, and
a headrest frame,
wherein the headrest frame is bridged between the panel frame and the reinforcement frame and bonded to the panel frame and the reinforcement frame.

An invention according to the second solution is the panel frame structure according to the first solution,
wherein the reinforcement frame has a reinforcement, and
wherein a mounted portion of the headrest frame on the reinforcement frame side is bonded to the reinforcement of the reinforcement frame.

An invention according to the third solution is the panel frame structure according to the first solution or the second solution,
wherein the panel frame has a reinforcement in an arrangement overlapped on a mounted position of a mounted portion of the headrest frame on the reinforcement frame side in a direction opposed to a plate surface of the panel frame structure.

An invention according to the fourth solution is the panel frame structure according to the third solution,
wherein a through-hole is formed in the reinforcement of the panel frame.

An invention according to the fifth solution is the panel frame structure according to any one of the first solution to the fourth solution,
wherein the panel frame has a plurality of reinforcements, and
wherein a mounted portion of the headrest frame on the panel frame side is bonded to a place between two of the reinforcements of the panel frame.

An invention according to the sixth solution is the panel frame structure according to any one of the first solution to the fifth solution,
wherein the panel frame has a reinforcement, and
wherein a mounted portion of the headrest frame on the panel frame side is bonded in an arrangement aligned with the reinforcement of the panel frame.

An invention according to the seventh solution is the panel frame structure according to any one of the first solution to the sixth solution,
wherein the headrest frame is composed of a first member and a second member bonded to each other, and
wherein the first member and the second member each have a mounted portion on the panel frame or the reinforcement frame.

An invention according to the eighth solution is the panel frame structure according to the seventh solution,
wherein at least one of the first member and the second member is bridged between the panel frame and the reinforcement frame and bonded to the panel frame and the reinforcement frame.

An invention according to the ninth solution is the panel frame structure according to the seventh solution or the eighth solution,
wherein the first member and the second member are bonded through laser welding.

An invention according to the tenth solution is the panel frame structure according to any one of the first solution to the ninth solution,
wherein the headrest frame is bonded to the panel frame and the reinforcement frame through laser welding.

### Effects of Solution

In the panel frame structure according to the first solution, the headrest frame is bridged between and bonded to the panel frame and the reinforcement frame. A load is thus distributed to the panel frame and the reinforcement frame if an external force is applied to the headrest frame, and the mounting strength of the headrest frame is maintained high. Deflection of the panel frame structure under the external force applied to the headrest frame is also prevented.

In the panel frame structure according to the second solution, the mounted portion of the headrest frame on the reinforcement frame side is bonded to the reinforcement of the reinforcement frame. The mounting strength of the headrest frame is thus maintained high. Deflection of the panel frame structure under the external force applied to the headrest frame is also prevented.

In the panel frame structure according to the third solution, the panel frame has the reinforcement in an arrangement overlapped on the mounted position of the mounted portion of the headrest frame on the reinforcement frame side. The mounted state is thus maintained with high strength under the external force applied to the headrest frame. Deflection of the panel frame structure under the external force applied to the headrest frame is also prevented.

In the panel frame structure according to the fourth solution, the through-hole is formed in the reinforcement of the panel frame. Weight reduction because of the through-hole is thus accomplished while maintaining the strength by the reinforcement.

In the panel frame structure according to the fifth solution, the mounted portion of the headrest frame on the panel frame side is bonded to the place between the two reinforcements of the panel frame. The mounted state is thus maintained with high strength under the external force applied to the headrest frame. Deflection of the panel frame structure under the external force applied to the headrest frame is also prevented.

In the panel frame structure according to the sixth solution, the mounted portion of the headrest frame on the panel frame side is bonded in an arrangement aligned with the reinforcement of the panel frame. The mounted state is thus maintained with high strength under the external force applied to the headrest frame. Deflection of the panel frame structure under the external force applied to the headrest frame is also prevented.

The panel frame structure according to the seventh solution is composed of the first member and the second member constituting the headrest frame.

Structural flexibility of the headrest frame is thus increased such as by shaping the first member and the second member of the headrest frame to have open cross-sections with openings opposed to each other, and improvement in strength is achieved easily while accomplishing weight reduction of the headrest frame.

Since the first member and the second member each have the mounted portion on the panel frame or the reinforcement frame. The mounting strength of the headrest frame is thus maintained high.

In the panel frame structure according to the eighth solution, at least one of the first member and the second member is bridged between and bonded to the panel frame and the reinforcement frame. The mounting strength of the headrest frame is thus maintained high. Deflection of the panel frame structure under the external force applied to the headrest frame is also prevented.

In the panel frame structure according to the ninth solution, the first member and the second member are bonded through laser welding. The rigidity of the entire headrest frame is thus maintained high. Since the first member and the second member are coupled, the mounting strength of the first member and the second member is maintained high.

In the panel frame structure according to the tenth solution, the headrest frame is bonded to the panel frame and the reinforcement frame through laser welding. The mounting strength of the headrest frame is thus maintained high.

### Substance of Embodiment [3] Related to Panel Frame Structure

Hereinafter, an embodiment for carrying out the present invention will be described using the drawings. Technically preferable various limitations will be imposed on the following embodiments in order to carry out the present invention, but are not intended to limit the scope of the present invention to the following embodiment and illustrated examples.

The present embodiment is a panel frame structure to be applied to a backrest of a conveyance bench seat.

Although a conveyance provided with a bench seat to which the panel frame structure which will be described below is applied includes every conveyance that accommodates a human being and moves, such as a vessel, a flight vehicle, or a vehicle, the present embodiment will exemplify a case in which the panel frame structure is applied to a bench seat of a vehicle, in particular, an automobile.

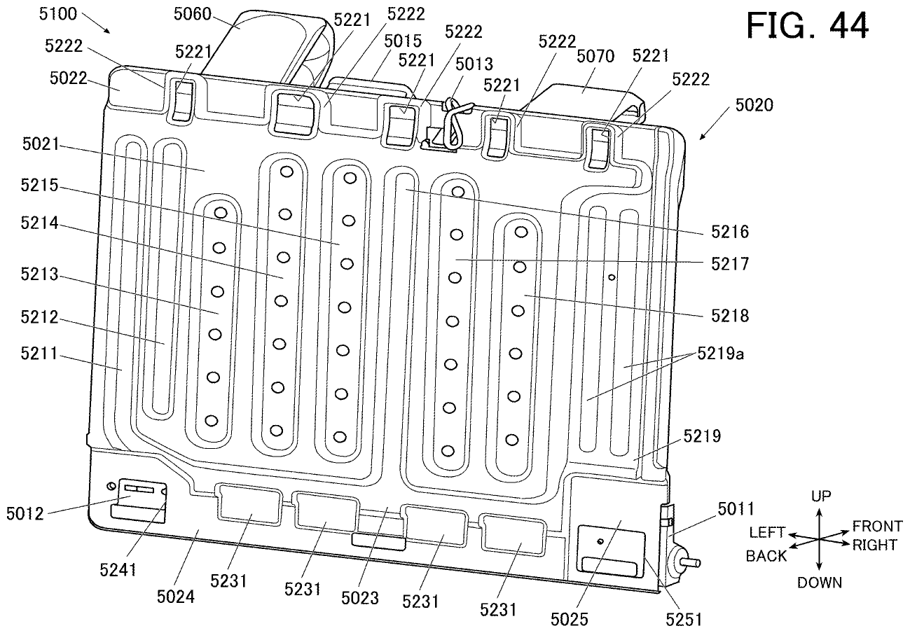

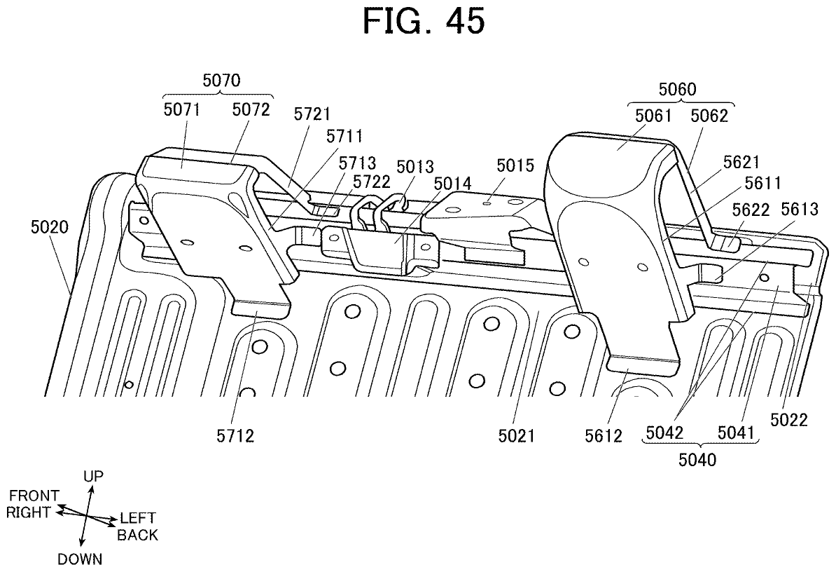

FIG. 43 is a perspective view illustrating a front surface side of a panel frame structure 5100. FIG. 44 is a perspective view illustrating a back surface side. FIG. 45 is a partial magnified perspective view of the panel frame structure 5100.

In each of the drawings, up, down, left, right, front, and back directions respectively indicate directions in a state in which the panel frame structure 5100 is mounted on a vehicle. Hereinafter, each part of the panel frame structure 5100 will be described based on the directions in the above-described mounted state.

More precisely, each panel frame structure 5100 is mounted on the vehicle in a state in which its upper end is somewhat inclined backward, but unless otherwise specified, a plate surface of each panel frame structure 5100 shall be in a state lying in the up-down direction and the left-right direction for the sake of description.

The panel frame structure 5100 is intended for a vehicle and utilized as a framework of a backrest of a bench seat. The panel frame structure 5100 is utilized for a backrest of a two-person bench seat.

A foam-molded pad is mounted on the panel frame structure 5100 from the front side so as to enclose the panel frame structure 5100. Foam-molded pads are also mounted on headrest frames 5060, 5070 of the panel frame structure 5100 which will be described later in an enclosing manner. Surface skins are then pulled over surfaces of these pads. Pulling over indicates that the surface skins covering the surfaces of the pads stretch over the surfaces of the pads under tension.

### [Overview of Panel Frame Structure]

The panel frame structure 5100 includes a panel frame 5020, reinforcement frames 5040, 5050, the headrest frames 5060, 5070, set brackets 5011, 5012, a striker 5013, a striker support bracket 5014, a belt guide bracket 5015, and the like.

The panel frame 5020 is a substantially rectangular metal plate of steel, aluminum alloy, or the like, and is deployed on the vehicle seat in a state in which upper and lower sides of the panel frame 5020 extend in the left-right direction and left and right sides extend in the up-down directions, as illustrated in FIG. 43.

### [Overview of Panel Frame]

The above-described panel frame 5020 is a metal plate having a substantially rectangular plate surface shape in front view as illustrated in FIG. 43 and FIG. 44.

The respective components of the panel frame structure 5100 are bonded through welding, more preferably through laser welding unless otherwise mentioned. However, a welding method other than laser welding may be used, or a bonding method other than welding may be used.

The panel frame 5020 has formed thereon a low-height, circumferential wall-like flange 5201 raised forward over substantially the entire circumference of its outer edge portion. Only a right end lower portion of the panel frame 5020 to be a mounted position of the set bracket 5011 which will be described later and an upper end central portion along which a backward folded portion of the striker 5013 passes have been removed from this flange 5201.

At left and right edges of the panel frame 5020, ribs protruding to the front side in the up-down direction are formed at corners of the root of the flange 5201. These ribs serve as a reinforcing structure that increases the rigidity of the panel frame 5020 in conjunction with the flange 5201.

A region of the panel frame 5020 excluding the upper end, lower end, and right end is a first planar portion 5021 positioned at the backmost side of the panel frame 5020, and the upper end of the panel frame 5020 is a second planar portion 5022 positioned ahead of the first planar portion 5021.

A third planar portion 5023 positioned ahead of the first planar portion 5021 is provided immediately below the first planar portion 5021. A fourth planar portion 5024 positioned ahead of the third planar portion 5023 is provided further below the third planar portion 5023. A fifth planar portion 5025 positioned ahead of the fourth planar portion 5024 is provided at the right side of the fourth planar portion 5024. The respective planar portions 5021 to 5025 each have a planar shape lying in the up-down and left-right directions.

The expression “ahead of” for the above-described first to fifth planar portions 5021 to 5025 indicates that the front surface of each of the first to fifth planar portions 5021 to 5025 is ahead of the front surface of another planar portion to be compared and that the back surface of each of the first to fifth planar portions 5021 to 5025 is also ahead of the back surface of the other planar portion to be compared.

On the panel frame 5020, the first to fifth planar portions 5021 to 5025 and a reinforcing structure in each portion which will be described later are formed by press-working a single flat plate, and they are integrated.

Low-height differences in level are formed along the boundaries of the first to fifth planar portions 5021 to 5025, and the differences in level also serve as reinforcing structures for the entire plate surface of the panel frame 5020.

Nine bead-like first reinforcements 5211 to 5219 implemented by strip-shaped bulging portions extending in the up-down direction are formed on the first planar portion 5021 as illustrated in FIG. 43.

These first reinforcements 5211 to 5219 are arranged in parallel in the left-right direction and are formed to protrude forward on the front surface of the first planar portion 5021 and to be recessed forward on the back surface.

Each of the first reinforcements 5211 to 5218 has a protruding height to the front side flush with the third planar portion 5023, and the first reinforcements 5211 and 5216 continue into the third planar portion 5023.

The expression “continue” indicates a state in which the plate surface continues without creating any difference in level.

The first reinforcements 5213, 5214, 5215, 5217, and 5218 have widths in the left-right direction greater than the widths of the other first reinforcements 5211, 5212, and 5216, and a plurality of circular through-holes are formed to be aligned in the long-side direction.

The first reinforcement 5219 positioned in the vicinity of a right end of the first planar portion 5021 has the greatest width in the left-right direction among the first reinforcements 5211 to 5219, and has a protruding height to the front side somewhat higher than the protruding height of the first reinforcements 5211 to 5218. This first reinforcement 5219 has a flat surface bulging forward and has two bead-like inner-side reinforcements 5219a in the up-down direction on the flat surface. These inner-side reinforcements 5219a are formed to be recessed backward on the front surface of the flat surface of the first reinforcement 5219 and to protrude backward on the back surface.

The expression “ . . . reinforcements” in the following description shall indicate portions or members having rigidity higher than the rigidity of a flat plate because of three-dimensional structures such as ridges, frame shapes, protrusions, and bends.

A plurality of (five in the present embodiment) rectangular through-holes 5221 for the bonding operation with rounded corners are formed to be aligned in the left-right direction in the second planar portion 5022, as illustrated in FIG. 44.

The headrest frames 5060, 5070, the striker support bracket 5014, and the belt guide bracket 5015 mentioned earlier each have a mounted portion to be bonded through welding such as laser welding to the front surface side of the reinforcement frame 5040 bonded to the front surface side of the panel frame 5020.

In the case in which these members 5060, 5070, 5014, 5015 are bonded to the reinforcement frame 5040, bonding them from behind the panel frame 5020 is preferable in terms of operating efficiency similarly to the operation of bonding each of the reinforcement frames 5040, 5050 to the panel frame 5020. In that case, however, interference of the panel frame 5020 makes it difficult to radiate laser to bonded locations between the reinforcement frame 5040 and the members 5060, 5070, 5014, 5015.

The through-holes 5221 for the bonding operation that allow passage of laser light are thus formed at respective positions in the panel frame 5020 that correspond to the bonded locations of the respective members 5060, 5070, 5014, and 5015 on the reinforcement frame 5040.

The through-holes 5221 for the bonding operation can also be utilized in a case in which another type of welding other than laser welding is selected.

The above-described respective through-holes 5221 are formed at the same locations as five second reinforcements 5222 formed on the second planar portion 5022.

In other words, the second reinforcements 5222 implemented by ridges along inner edge portions of the respective through-holes 5221 are formed on the back surface side of the second planar portion 5022. The respective second reinforcement 5222 are formed in an arrangement that reaches the upper end of the panel frame 5020.

Each of the second reinforcements 5222 is formed to protrude backward on the back surface of the second planar portion 5022 and to be recessed backward in the front surface. Each of the second reinforcements 5222 has a protruding height to the back side substantially flush with the first planar portion 5021, and the lower end of each of the second reinforcements 5222 continues into the first planar portion 5021.

Each of the second reinforcements 5222 has a circumferential wall shape obtained by raising the inner edge of the through-hole 5221 forward. Consequently, in a case in which a user inserts his/her finger into each of the through-holes 5221 when handling the panel frame structure 5100 or the panel frame 5020, he/she touches the circumferential wall surface smoothly.

The third planar portion 5023 is adjacent to the lower side of the first planar portion 5021 and extends in the left-right direction. The fourth planar portion 5024 positioned at the lower end of the panel frame 5020 is adjacent to the lower side of the third planar portion 5023, and the fourth planar portion 5024 also extends in the left-right direction.

As mentioned earlier, the third planar portion 5023 is positioned ahead of the first planar portion 5021, and the fourth planar portion 5024 is positioned further ahead of the third planar portion 5023.

A boundary line between the third planar portion 5023 and the fourth planar portion 5024 extends in the left-right direction, and a plurality of (four in the present embodiment) third reinforcements 5231 are formed on the boundary line in a manner bridged between the third planar portion 5023 and the fourth planar portion 5024.

Each of the third reinforcements 5231 is a structure bulging forward as a rectangular shape with rounded corners, and its bulging portion has a rounded, rectangular planar portion. Each of the third reinforcements 5231 bulges forward relative to the third planar portion 5023 and the fourth planar portion 5024. Each of the third reinforcements 5231 is formed to protrude forward on the front surfaces of the third planar portion 5023 and the fourth planar portion 5024 and to be recessed forward on the back surfaces.

A left end of the fourth planar portion 5024 is positioned at a left lower corner of the panel frame 5020 and has a width in the up-down direction greater than the width of another region. The set bracket 5012 having a rectangular flat plate-shape is bonded to the front surface side of the left end of the fourth planar portion 5024. The height in the front-back direction of a front surface of this set bracket 5012 agrees with the height in the front-back direction of the front surface of the planar portion of each of the aforementioned third reinforcements 5231.

A left end of the reinforcement frame 5050 is bonded to the front surface of the set bracket 5012 through laser welding. Consequently, an opening 5241 for the operation of bonding the reinforcement frame 5050 to the set bracket 5012 is formed widely so as to extend through the fourth planar portion 5024 at a mounted position of the set bracket 5012 on the fourth planar portion 5024. This opening 5241 presents a substantially rectangular shape smaller than the set bracket 5012.

The fifth planar portion 5025 is positioned at the right lower corner of the panel frame 5020 and is adjacent to the right side of the third planar portion 5023 and the fourth planar portion 5024. As mentioned earlier, the fifth planar portion 5025 is positioned at the frontmost side among the first to fifth planar portions 5021 to 5025.

A planar-shaped base end of the set bracket 5011 is bonded to the front surface side of the fifth planar portion 5025. The height in the front-back direction of the front surface of the base end of this set bracket 5011 agrees with the height in the front-back direction of the front surface of the planar portion of each of the aforementioned third reinforcements 5231 and the front surface of the set bracket 5012.

A right end of the reinforcement frame 5050 is bonded to the front surface of the set bracket 5011 through laser welding. Consequently, an opening 5251 for the operation of bonding the reinforcement frame 5050 to the set bracket 5011 is formed widely so as to extend through the fifth planar portion 5025 at a mounted position of the set bracket 5011 on the fifth planar portion 5025. This opening 5251 presents a substantially rectangular shape smaller than the base end of the set bracket 5011.

### [Reinforcement Frame]

The reinforcement frames 5040, 5050 are metallic struts formed by press-working a flat plate of steel, aluminum alloy, or the like.

As illustrated in FIG. 43, the reinforcement frames 5040, 5050 respectively have reinforcements 5041, 5051 which are long and shaped to have open cross-sections presenting substantially U-shaped cross sections, and pairs of flanges 5042, 5052 formed at opposite ends on the open side of the reinforcements 5041, 5051. The pairs of flanges 5042, 5052 have planar portions opposed to the panel frame 5020 and are bonded to the panel frame 5020 through laser welding in a state in which the planar portions are in surface contact with the panel frame 5020.

The reinforcement frames 5040, 5050 are bonded respectively to the upper end and the lower end on the front surface side of the panel frame 5020 in a state in which their long-side direction is oriented in the left-right direction.

Describing in more detail, the reinforcement frame 5040 has the upper one of the flanges 5042 bonded to the front surface side of the second planar portion 5022 of the panel frame 5020 and the lower one of the flanges 5042 bonded to the front surface side of the first planar portion 5021.

The upper one of the flanges 5042 of the reinforcement frame 5040 is bonded at a plurality of locations on the second planar portion 5022 skirting the through-holes 5221 and the second reinforcement 5222.

The lower one of the flanges 5042 is bonded at a plurality of locations on the front surface of the upper end on the first planar portion 5021 where the respective first reinforcements 5211 to 5219 are absent.

The pair of flanges 5052 of the reinforcement frame 5050 are bonded at a plurality of locations on the front surfaces of the plurality of third reinforcements 5231 and the front surfaces of the set brackets 5011, 5012 having the same height in the front-back direction.

### [Set Brackets]

As illustrated in FIG. 43, the right set bracket 5011 has a planar-shaped base end bonded to a right end lower portion of the front surface of the panel frame 5020, that is, the front surface of the fifth planar portion 5025, and a support arm 5111 extended forward from the base end. The set bracket 5011 is a member obtained by press-working a metal plate thicker than the panel frame 5020 to obtain a three-dimensional structure.

A right end of the reinforcement frame 5050 is bonded to the front surface of the base end of the set bracket 5011 as mentioned earlier.

A support hole through which a support shaft 5112 that supports the panel frame structure 5100 is to be inserted is formed to extend through a leading end of the support arm 5111 in the left-right direction.

As illustrated in FIG. 43, the left set bracket 5012 is bonded through laser welding to the front surface side of a left end lower portion of the panel frame 5020, that is, a left end of the fourth planar portion 5024.

A left end of the reinforcement frame 5050 is bonded to the front surface of the left set bracket 5012 as mentioned earlier.

The set bracket 5012 is a member made of a metal plate thicker than the panel frame 5020. This set bracket 5012 has a projection nut 5121 fixedly deployed on the left end of the front surface through projection welding. A fixation bolt is threaded into the projection nut 5121 when the panel frame structure 5100 is fixed to a vehicle seat.

### [Headrest Frames]

As illustrated in FIG. 45, the headrest frames 5060, 5070 are respectively composed of the first members 5061, 5071 and the second members 5062, 5072 provided in a manner standing toward an obliquely upper side to the front on the upper end of the panel frame 5020. The first members 5061, 5071 are positioned at the front side, and the second members 5062, 5072 are positioned at the back side. The first members 5061, 5071 and the second members 5062, 5072 are metallic members respectively formed three-dimensionally by press-working a flat plate of steel, aluminum alloy, or the like.

The first members 5061, 5071 have a plate shape extending in the standing direction, and their upper ends are curved backward. The second members 5062, 5072 have a plate shape extending in the standing direction, and their upper ends are curved forward. The upper ends of the first members 5061, 5071 are overlapped on the upper ends of the second members 5062, 5072 from above, and these overlapped portions are bonded through laser welding to be integrated.

The above-described first members 5061, 5071 have flange-like lateral portions 5611, 5711 oriented backward at left and right lateral ends over substantially the entire length in the extending direction of the first members 5061, 5071. The second members 5062, 5072 respectively have flange-like lateral portions 5621, 5721 oriented forward at left and right lateral ends over substantially the entire length in the extending direction of the second members 5062, 5072.

Consequently, the shape of cross sections perpendicular to the above-described extending direction of the first members 5061, 5071 is a substantially U-shape (shaped to have an open cross-section) with openings oriented backward. The shape of cross sections perpendicular to the above-described extending direction of the second members 5062, 5072 is a substantially U-shape (shaped to have an open cross-section) with openings oriented forward.

As described above, the headrest frames 5060, 5070 have high rigidity against a stress in the front-back direction with the lateral portions 5611, 5711, 5621, 5721 of the respective members serving as a reinforcing structure because of a combined structure of the first members 5061, 5071 with the open side of the open cross-sectional shape oriented backward and the second members 5062, 5072 with the open side of the open cross-sectional shape oriented forward.

The second members 5062, 5072 are provided in a standing manner in a state closer to perpendicularity to the plate surface of the panel frame 5020 than the first members 5061, 5071. The second members 5062, 5072 serve as a structure that supports the entire headrest frames 5060, 5070 against a backward compression force on the first members 5061, 5071 and have particularly high rigidity against a backward stress.

The first members 5061, 5071 respectively have mounted portions 5612, 5712 to be bonded to the first planar portion 5021 of the panel frame 5020, at lower ends of substantially flat plate-like portions extending in the standing direction. The first members 5061, 5071 also have pairs of left and right mounted portions 5613, 5713 respectively extended obliquely upward to the back from the left and right lateral portions 5611, 5711 and bonded to the front surface of the reinforcement 5041 of the reinforcement frame 5040 at their leading ends.

As described above, the first members 5061, 5071 are bridged between the panel frame 5020 and the reinforcement frame 5040 in the front-back direction and bonded to the panel frame 5020 and the reinforcement frame 5040.

The second members 5062, 5072 respectively have pairs of left and right mounted portions 5622, 5722 extended from left and right lateral portions 5621, 5721 in the extending direction of the second members 5062, 5072 and bonded to the upper surface of the flange 5042 of the reinforcement frame 5040 at their leading ends.

The mounted portion 5612 of the first member 5061 is bonded to a position sandwiched by the two first reinforcements 5212, 5214 from the left and right on the front surface of the first planar portion 5021 of the panel frame 5020, the position being adjacent to the first reinforcement 5213 in its planar direction (the up-down direction) as illustrated in FIG. 43.

The mounted portion 5712 of the first member 5071 is bonded to a position sandwiched by the two first reinforcements 5217, 5219 from the left and right on the front surface of the first planar portion 5021 of the panel frame 5020, the position being adjacent to the first reinforcement 5218 in its planar direction (the up-down direction) as illustrated in FIG. 43.

As described above, the mounted portions 5612, 5712 are bonded to the positions on the first planar portion 5021 around which the first reinforcements 5212 to 5214, 5217 to 5219 are formed. Deflection of the panel frame 5020 is thus prevented even in a case in which a stress is applied from the headrest frames 5060, 5070, and the bonding strength of the mounted portions 5612, 5712 is maintained high.

The left mounted portion 5613 of the first member 5061 and the left mounted portion 5622 of the second member 5062 are bonded to the reinforcement frame 5040 at positions overlapped on the leftmost through-hole 5221 formed in the second planar portion 5022 of the panel frame 5020 in the direction perpendicular to the plate surface of the panel frame 5020 as illustrated in FIG. 44.

Similarly, the right mounted portion 5613 of the first member 5061 and the right mounted portion 5622 of the second member 5062 are bonded to the reinforcement frame 5040 at positions overlapped on the second-leftmost through-hole 5221 formed in the second planar portion 5022 of the panel frame 5020 in the direction perpendicular to the plate surface of the panel frame 5020.

The left mounted portion 5713 of the first member 5071 and the left mounted portion 5722 of the second member 5072 are bonded to the reinforcement frame 5040 at positions overlapped on the second-rightmost through-hole 5221 formed in the second planar portion 5022 of the panel frame 5020 in the direction perpendicular to the plate surface of the panel frame 5020 as illustrated in FIG. 44.

Similarly, the right mounted portion 5713 of the first member 5071 and the right mounted portion 5722 of the second member 5072 are bonded to the reinforcement frame 5040 at positions overlapped on the rightmost through-hole 5221 formed in the second planar portion 5022 of the panel frame 5020 in the direction perpendicular to the plate surface of the panel frame 5020.

The second reinforcement 5222 protruding backward is formed along the inner edge portion of each of the through-holes 5221.

Consequently, since the left and right mounted portions 5613, 5713 of the first members 5061, 5071 and the left and right mounted portions 5622, 5722 of the second members 5062, 5072 are bonded to the reinforcement frame 5040 in the arrangement overlapped on the range around which the second reinforcement 5222 extends, deflection of the panel frame 5020 is prevented even in a case in which a compression force, a tensile force, an impact, or the like is applied from the headrest frames 5060, 5070, and the bonding strength of the mounted portions 5613, 5713, 5622, 5722 is maintained high.

Since the left and right mounted portions 5613, 5713 of the first members 5061, 5071 of the headrest frames 5060, 5070 are bonded to the reinforcement 5041 of the reinforcement frame 5040, deflection of the panel frame 5020 is further prevented, and the bonding strength of the mounted portions 5613, 5713 is maintained higher.

### [Striker and Striker Support Bracket]

As illustrated in FIG. 43, the striker 5013 is a metal fitting for fixing, to the vehicle body, the panel frame structure 5100 to serve as a backrest of a bench seat. The striker 5013 is obtained by bending a thick wire rod made of metal. The wire rod has opposite ends bonded to the striker support bracket 5014 through laser welding, and a middle portion of the annular wire rod is bent into a hook shape folded backward from the upper end of the panel frame 5020 and further extended downward.

The striker support bracket 5014 has a main body to which the striker 5013 is bonded, and mounted portions extended in respective directions to the left and right from left and right opposite ends of the main body. The striker support bracket 5014 is a metallic member formed three-dimensionally by press-working a flat plate of steel, aluminum alloy, or the like.

The left and right mounted portions of the striker support bracket 5014 are bonded to the front surface of the reinforcement 5041 of the reinforcement frame 5040.

The left mounted portion of the striker support bracket 5014 is bonded to the reinforcement frame 5040 at a position overlapped on the central through-hole 5221 formed in the second planar portion 5022 of the panel frame 5020 in the direction perpendicular to the plate surface of the panel frame 5020 as illustrated in FIG. 44.

The right mounted portion of the striker support bracket 5014 is bonded to the reinforcement frame 5040 at a position overlapped on the second-rightmost through-hole 5221 formed in the second planar portion 5022 of the panel frame 5020 in the direction perpendicular to the plate surface of the panel frame 5020.

Consequently, since the left and right mounted portions of the striker support bracket 5014 are bonded to the reinforcement frame 5040 in the arrangement overlapped on the range around which the second reinforcement 5222 extends, deflection of the panel frame 5020 is prevented even in the case in which a compression force, a tensile force, an impact, or the like is applied from the striker 5013, and the bonding strength of the mounted portions is maintained high.

Since the left and right mounted portions of the striker support bracket 5014 are bonded to the reinforcement 5041 of the reinforcement frame 5040, deflection of the panel frame 5020 is further prevented, and the bonding strength of the striker support bracket 5014 is maintained higher.

### [Belt Guide Bracket]

The belt guide bracket 5015 is a member to serve as a seating that supports the belt guide not illustrated of the seat belt and has a main body that supports the belt guide, mounted portions extended in the respective directions to the left and right from left and right opposite ends of the main body, and a mounted portion extended downward. The belt guide bracket 5015 is a metallic member formed three-dimensionally by press-working a flat plate of steel, aluminum alloy, or the like.

The downward-extended mounted portion of the belt guide bracket 5015 is bonded to the front surface of the reinforcement 5041 of the reinforcement frame 5040.

The leftward-extended mounted portion of the belt guide bracket 5015 is bonded to the reinforcement frame 5040 at a position overlapped on the second-leftmost through-hole 5221 formed in the second planar portion 5022 of the panel frame 5020 in the direction perpendicular to the plate surface of the panel frame 5020 as illustrated in FIG. 44.

Similarly, the rightward-extended mounted portion of the belt guide bracket 5015 is bonded to the reinforcement frame 5040 at a position overlapped on the central through-hole 5221 formed in the second planar portion 5022 of the panel frame 5020 in the direction perpendicular to the plate surface of the panel frame 5020.

Consequently, since the left and right mounted portions of the belt guide bracket 5015 are bonded to the reinforcement frame 5040 in the arrangement overlapped on the range around which the second reinforcement 5222 extends, deflection of the panel frame 5020 is prevented even in the case in which a compression force, a tensile force, an impact, or the like is applied from the belt guide, and the bonding strength of the left and right mounted portions of the belt guide bracket 5015 is maintained high.

Since the downward-extended mounted portion of the belt guide bracket 5015 is bonded to the reinforcement 5041 of the reinforcement frame 5040, deflection of the panel frame 5020 is prevented even in the case in which a compression force, a tensile force, an impact, or the like is applied from the belt guide, and the bonding strength of the downward-extended mounted portion is maintained high.

### Technical Effects of Embodiment of Invention

In the above-described panel frame structure 5100, the headrest frames 5060, 5070 are bridged between and bonded to the panel frame 5020 and the reinforcement frame 5040. A load is thus distributed to the panel frame 5020 and the reinforcement frame 5040 if an external force is applied to the headrest frames 5060, 5070, and the mounting strength of the headrest frames 5060, 5070 is maintained high. Deflection of the panel frame structure 5100 under the external force applied to the headrest frames 5060, 5070 is also prevented.

Particularly since the first members 5061, 5071 of the headrest frames 5060, 5070 are bridged between and bonded to the panel frame 5020 and the reinforcement frame 5040, the mounting strength of the first members 5061, 5071 is maintained high.

In the above-described panel frame structure 5100, the mounting strength of the entire headrest frames 5060, 5070 is improved effectively from reasons such as that the first members 5061, 5071 are positioned on the front side and the second members 5062, 5072 are positioned on the back side, the first members 5061, 5071 are inclined to the back side, the second members 5062, 5072 are closer to perpendicularity to the plate surface of the panel frame 5020, and a backward compression force is often applied to the headrest frames 5060, 5070.

Since the headrest frames 5060, 5070 are bonded to the panel frame 5020 and the reinforcement frame 5040 through laser welding, the mounting strength of the headrest frames is maintained higher.

In the panel frame structure 5100, the mounted portions 5613, 5713 of the headrest frames 5060, 5070 on the reinforcement frame 5040 side are bonded to the reinforcement 5041 of the reinforcement frame 5040. The mounting strength of the headrest frames 5060, 5070 is thus maintained still higher. Deflection of the panel frame structure 5100 under the external force applied to the headrest frames 5060, 5070 is also prevented.

In the panel frame structure 5100, the panel frame 5020 has the second reinforcement 5222 in the arrangement overlapped on the mounted positions of the mounted portions 5613, 5713, 5622, 5722 of the headrest frames 5060, 5070 on the reinforcement frame 5040 side. The mounted state is thus maintained with high strength under an external force applied to the headrest frames 5060, 5070. Deflection of the panel frame structure 5100 under the external force applied to the headrest frames 5060, 5070 is also prevented.

In the panel frame structure 5100, the through-holes 5221 are formed in the second reinforcement 5222 of the panel frame 5020. Weight reduction because of the through-holes 5221 is thus accomplished while maintaining the strength by the second reinforcement 5222. These through-holes 5221 are also utilized for the operation of bonding the respective members 5060, 5070, 5014, 5015 and also contribute to improvement in efficiency of the bonding operation.

Through-holes are also formed in the first reinforcements 5213 to 5215, 5217, and 5218, and weight reduction because of these through-holes is accomplished while maintaining the strength.

In the panel frame structure 5100, the mounted portions 5612, 5712 of the headrest frames 5060, 5070 on the panel frame 5020 side are bonded respectively between the two first reinforcements 5212 and 5214 and between 5217 and 5219 of the panel frame 5020, and the mounted portions 5612, 5712 are bonded respectively in the arrangement aligned with the first reinforcements 5213, 5218 in the up-down direction.

Consequently, the mounted state is maintained with high strength under an external force applied to the headrest frames 5060, 5070. Deflection of the panel frame structure 5100 under the external force applied to the headrest frames 5060, 5070 is also prevented.

The panel frame structure 5100 is composed of the first members 5061, 5071 and the second members 5062, 5072 respectively constituting the headrest frames 5060, 5070.

The headrest frames 5060, 5070 are thus increased in structural flexibility such as by shaping the first members 5061, 5071 and the second members 5062, 5072 of the headrest frames to have the open cross-sections with the openings opposed to each other to provide the headrest frames 5060, 5070 having higher rigidity. Improvement in strength is achieved easily while accomplishing weight reduction of the headrest frames 5060, 5070.

Since the first members 5061, 5071 and the second members 5062, 5072 respectively constituting the headrest frames 5060, 5070 are bonded through laser welding, the bonding strength is increased to maintain the rigidity of the entire headrest frames 5060, 5070 high.

### [Others]

The structure in which the respective reinforcements formed on the panel frame 5020 of the panel frame structure 5100 are all obtained by deforming the plate material of the panel frame 5020 to form protrusions or ridges, thereby increasing the strength and rigidity has been exemplified. However, the reinforcements are not limited to them, and a structure in which bends are formed on the plate material of the panel frame 5020 to increase the strength and rigidity, or the like, for example, may be utilized.

However, the above-described various reinforcements may be configured by bonding or attaching new members to the panel frame 5020, but a configuration obtained by altering or deforming the plate material of the panel frame 5020 to increase the strength and rigidity is more preferable.

Although the panel frame structure 5100 provided with the two headrest frames 5060, 5070 and used for a laterally-wide two-person bench seat has been exemplified as an embodiment of the invention, the technical characteristics of the panel frame structure 5100 may be applied to a panel frame structure provided with a single headrest frame to reduce the lateral width to be used for a one-person seat.

Similarly, the technical characteristics of the panel frame structure 5100 may be applied to a panel frame structure provided with more than two headrest frames to increase the lateral width to be used for a seat for more than two persons.

The panel frame structure 5100 having a substantially rectangular shape has been exemplified, but may have a substantially square shape.

### INDUSTRIAL APPLICABILITY

The present invention has industrial applicability for panel frame structures.

### REFERENCE SIGNS LIST

2020 panel frame
2021 to 2024 parallel reinforcement
2025 central reinforcement
2026, 2027 stepped reinforcement
2040 upper frame
2041 columnar portion
2042 flange
2043 front surface portion
2044 bend
2045 guide
2050 lower frame
2051 columnar portion
2052 flange
2060, 2070 side frame
2061, 2071 columnar portion
2062, 2072 flange
2080 mounting bracket
2081 lower portion
2082 upper portion
2083 to 2086 flange
2087 clearance space
2088 bulging portion
2089 sidewall
2090 armrest bracket
2091 main body
2092 bypass portion
2093, 2094 arm
2095 reinforcement
2100 panel frame structure
2110 lock device
2111 bolt (fastener)
2112 nut (fastener)
2120, 2130 corner bracket
2121 flange
2122 flange
2131 flange
2132 flange
2140 belt guide
2141 insertion portion
2142 leg
2150 support
2160 airbag module
2201 flange
BS seat belt

1. A panel frame structure comprising:
a panel frame;
an upper frame bonded along an upper end of the panel frame;
a side frame bonded along a lateral end of the panel frame; and
a mounting bracket for a lock device,
wherein the mounting bracket has a portion overlapped on the upper frame when viewed in a front-back direction.

2. The panel frame structure according to claim 1, wherein the mounting bracket is in a state covering at least part of the upper frame.

3. The panel frame structure according to claim 1, wherein the side frame, the mounting bracket, and the upper frame have overlapped portions when viewed in the front-back direction.

4. The panel frame structure according to claim 1, wherein a clearance space in which a fastener for mounting the lock device is arranged is provided between the mounting bracket and the upper frame.

5. The panel frame structure according to claim 4, wherein the fastener is bonded to a sidewall that forms the clearance space.

6. The panel frame structure according to claim 4, wherein the mounting bracket has the clearance space on an inner side of a region protruding in the front-back direction.

7. The panel frame structure according to claim 3, wherein the mounting bracket is bonded to at least one of the upper frame or the side frame and to the panel frame.

8. The panel frame structure according to claim 1, wherein a clearance space in which the lock device is stored is provided between the mounting bracket and the upper frame.

9. The panel frame structure according to claim 1, further comprising:
an armrest bracket that supports an armrest; and
a corner bracket bonded to a corner of the panel frame,
wherein the armrest bracket has a portion overlapped on the side frame or the corner bracket when viewed in the front-back direction.

10. The panel frame structure according to claim 9, wherein the armrest bracket is bonded to the side frame or the corner bracket.

11. The panel frame structure according to claim 9, wherein the armrest bracket is bonded to neither the side frame nor the corner bracket.

12. The panel frame structure according to claim 9, wherein the armrest bracket is shaped to skirt the side frame or the corner bracket in the front-back direction.

13. The panel frame structure according to claim 1,
wherein the upper frame is shaped to have an open cross-section, and
wherein a protruding/recessed reinforcement is provided at a position to be an inner side of an opening of the open cross-section of the upper frame on the panel frame.

14. The panel frame structure according to claim 1,
wherein the upper frame or the side frame is shaped to have an open cross-section, and
wherein a protruding/recessed reinforcement is provided to be aligned with an outside of an opening of the open cross-section of the upper frame or the side frame on the panel frame.

15. The panel frame structure according to claim 1, wherein a netted bead is formed on the panel frame.
